(19) United States
(12) Patent Application Publication
(10) Pub. No.: US 2003/0065568 A1
(43) Pub. Date: Apr. 3, 2003

(54) Terminal apparatus suspending and resuming a transaction between an article registration device and a settlement device

(75) Inventors: Takamasa Kondo, Kawasaki (JP); Yoshihiro Kodaka, Kawasaki (JP); Yuko Muto, Kawasaki (JP); Shogo Adachi, Kawasaki (JP)

Correspondence Address: STAAS & HALSEY LLP, 700 11TH STREET, NW, SUITE 500, WASHINGTON, DC, 20001, US

(73) Assignee: FUJITSU LIMITED, Kawasaki (JP)

(21) Appl. No.: 10/095,055

(22) Filed: Mar. 12, 2002

(30) Foreign Application Priority Data
Sep. 28, 2001 (JP) 2001-302170

(51) Int. Cl. G06F 17/60

(52) U.S. Cl. 705/19; 705/20

(57) ABSTRACT

This terminal apparatus comprises an article registration device, a settlement device, an article registration suspending unit, an article registration resuming unit, a settlement suspending unit, and a settlement resuming unit. The article registration device inputs an article code so as to register a transaction. The settlement device creates transaction information according to the article code input by the article registration device so as to subject the transaction to a settling operation according to the transaction information. The article registration suspending unit suspends the transaction being registered by the article registration device in a suspended state. The article registration resuming unit resumes the transaction suspended in the suspended state into the article registration device. The settlement suspending unit suspends the transaction being subjected to the settling operation by the settlement device in the suspended state. The settlement resuming unit resumes the transaction suspended in the suspended state into the settlement device.

### BACKGROUND OF THE INVENTION

1. Field of the Invention

The present invention generally relates to a terminal apparatus, a transaction management system, a transaction processing method, and a program, and more particularly, to an article registration device, a settlement device, a transaction management system, a transaction managing method, and a program, which are used for registering transaction information of transacted goods and services so as to manage transactions.

Recently, large-scale and medium-scale stores have introduced POS (point-of-sale) systems so as to increase efficiency of distribution. The POS system comprises s POS terminal and a host device interconnected via a network. The POS terminal registers an article of commerce by reading a bar code applied on the article, creates transaction information on an individual transaction basis, and transmits the transaction information to the host device. The host device manages the transaction information as a transaction log.

Some POS terminals separately comprise an article registration device used for registering articles and a settlement device used for settling the articles, in which a twosome accounting operation can be performed by a checker exclusively performing an article registration by using the article registration device and a cashier exclusively using the settlement device.

In this twosome operation, when transactions stagnate at either side of the article registration device and the settlement device, an efficiency of the operation is extremely decreased. For example, when a customer leaves the POS terminal so as to add or exchange articles in the course of an article registration or a transaction settlement, the operators (the checker and the cashier) have to wait the customer to be back. Accordingly, the article registration and the settlement become stagnant. This problem has caused needs for a system that can efficiently deal with this circumstance.

2. Description of the Related Art

For the reason mentioned above, the settlement device of the conventional POS terminal has a suspension/resumption function for temporarily suspending a transaction and enabling a settlement for a next transaction, when a customer leaves the POS terminal so as to add or exchange articles in the course of the transaction.

In the twosome operation of the POS terminal, the checker performs an article registration by using the article registration device, and the cashier performs a settlement by using the settlement device. For example, when a customer leaves the POS terminal so as to add or exchange articles in the course of a transaction settlement, the transaction is suspended so as to enable a settlement for a next transaction. Thereby, the next transaction can be settled.

However, in the conventional POS terminal, since the suspension/resumption function is realized solely by the settlement device, the suspension/resumption function cannot be fully performed in a case where a preceding transaction is being settled by the settlement device, and articles to be purchased in a following transaction are being registered by the article registration device, because the articles being registered by the article registration device in the following transaction cannot be suspended/resumed, although the preceding transaction can be temporarily halted by the suspension/resumption function in the course of the settlement by the settlement device.

Therefore, even though the preceding transaction finishes being settled by the settlement device, the following transaction cannot be settled or, articles cannot be registered for a transaction after the following transaction, if the articles in the following transaction have not finished being registered by the article registration device for such a reason that a customer leaves the POS terminal so as to add or exchange articles in the course of the article registration by the article registration. Accordingly, transaction operations become stagnant.

### SUMMARY OF THE INVENTION

It is a general object of the present invention to provide an improved and useful article registration device, a settlement device, a transaction management system, a transaction managing method, and a program, in which the above-mentioned problems are eliminated.

A more specific object of the present invention is to provide an article registration device, a settlement device, a transaction management system, a transaction managing method, and a program, which can register articles of commerce to be purchased, and can settle the articles with efficiency.

In order to achieve the above-mentioned objects according to the present invention, a transaction, being registered by an article registering operation inputting an article code, can be suspended. Also, a transaction, being settled by a settling operation according to transaction information created thereby according to the input article code, can be suspended. Subsequently, the suspended transaction can be resumed so that the transaction is subjected to the article registering operation or the settling operation.

Additionally in the present invention, the transaction suspended in the course of the article registering operation can be resumed so that the transaction is subjected to the article registering operation, and the transaction suspended in the course of the settling operation can be resumed so that the transaction is subjected to the settling operation. Further, the transaction suspended in the course of the settling operation can be resumed so that the transaction is subjected to the article registering operation, and the transaction suspended in the course of the article registering operation can be resumed so that the transaction is subjected to the settling operation.

According to the present invention, since a transaction can be suspended and resumed in the article registering operation, the transaction can be suspended and resumed so as to add or exchange articles in the course of the article registering operation. Therefore, an article registering operation for a next transaction can be performed while the preceding transaction is suspended. Subsequently, the preceding transaction can be resumed so as to resume the article registering operation for the preceding transaction. Also, since a transaction can be suspended and resumed in the settling operation, the transaction can be suspended and resumed so as to add or exchange articles in the course of the settling operation. Therefore, a settling operation for a next transaction can be performed while the preceding transaction is suspended. Subsequently, the preceding transaction can be resumed so as to resume the article registering operation and the settling operation for the preceding transaction.

Further, a transaction suspended in the article registering operation can be resumed in the settling operation, and a transaction suspended in the settling operation can be resumed in the article registering operation. Therefore, the article registering operation and the settling operation can be performed efficiently in accordance with statuses thereof.

Other objects, features and advantages of the present invention will become more apparent from the following detailed description when read in conjunction with the accompanying drawings.

### BRIEF DESCRIPTION OF THE DRAWINGS

FIG. 1 is a diagram of a configuration of a transaction information management system according to an embodiment of the present invention;

FIG. 2 is a perspective view of a terminal apparatus shown in FIG. 1;

FIG. 3 is a block diagram of an article registration device shown in FIG. 2;

FIG. 4 illustrates a key layout of a multiple keyboard shown in FIG. 3;

FIG. 5 is a block diagram of a settlement device shown in FIG. 2;

FIG. 6 illustrates a key layout of a keyboard shown in FIG. 5;

FIG. 7 is a block diagram of a server shown in FIG. 1;

FIG. 8 illustrates a data configuration in a PLU master database domain shown in FIG. 7;

FIG. 9A and FIG. 9B illustrate a data configuration in a transaction log database domain shown in FIG. 7;

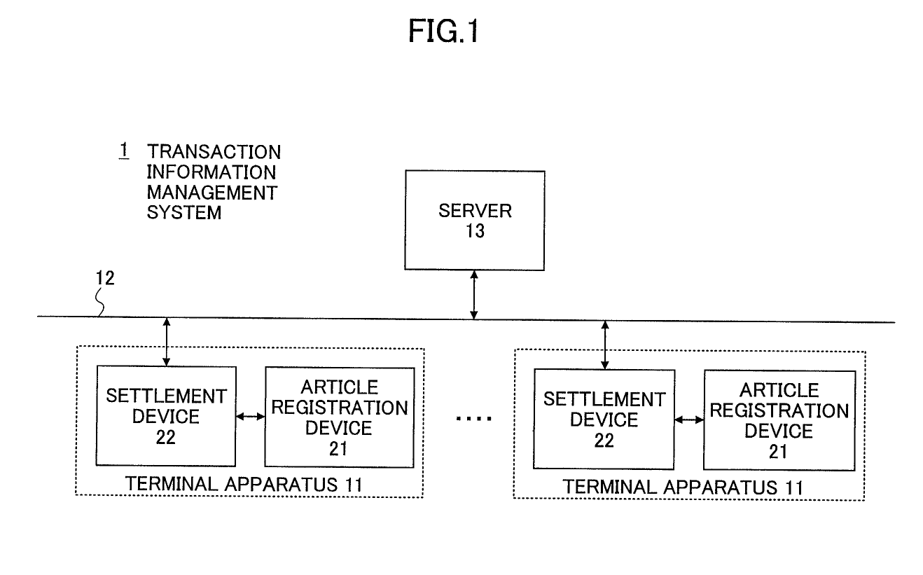

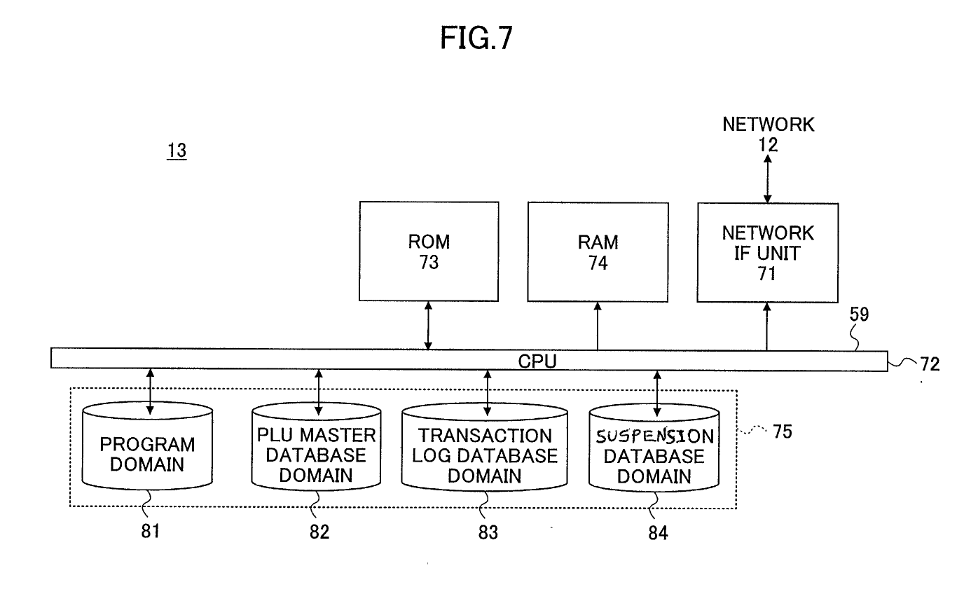

FIG. 1OA and FIG. 10B illustrate a data configuration in a suspension database domain shown in FIG. 7;

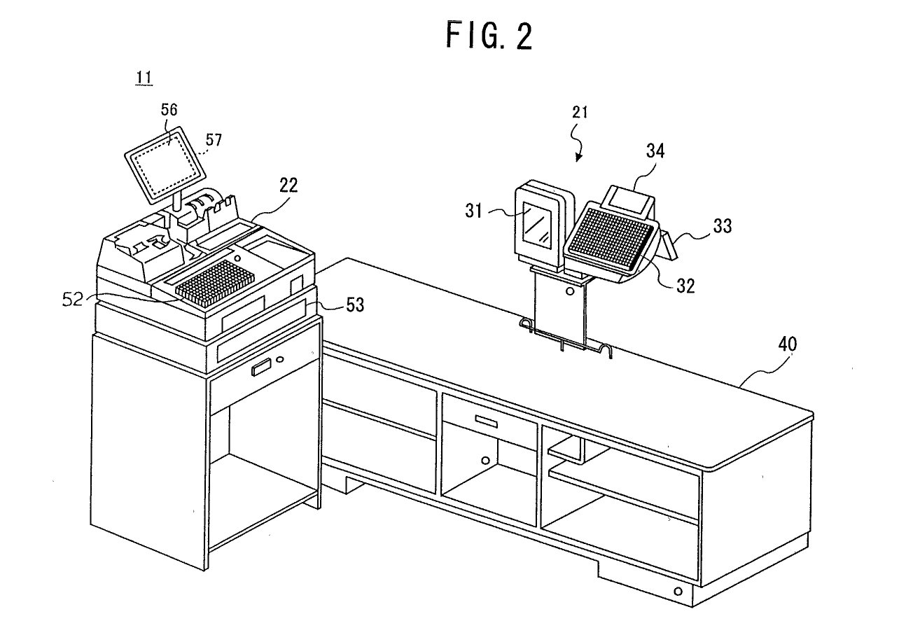

FIG. 11 is a transaction process flowchart of the article registration device shown in FIG. 2, when the article registration device suspends a transaction and resumes the transaction;

FIG. 12 is a transaction process flowchart of the settlement device shown in FIG. 2, when the article registration device suspends a transaction and resumes the transaction;

FIG. 13A to FIG. 13D are screen transition diagrams of a customer-side display and a checker-side display of the article registration device, when the article registration device suspends a transaction and resumes the transaction;

FIG. 14 is a transaction process flowchart of the article registration device, when the settlement device suspends a transaction and resumes the transaction;

FIG. 15 is a transaction process flowchart of the settlement device, when the settlement device suspends a transaction and resumes the transaction;

FIG. 16A to FIG. 16C and FIG. 17A to FIG. 17C are screen transition diagrams of the settlement device, when the settlement device suspends a transaction and resumes the transaction;

FIG. 18 is a transaction process flowchart of the article registration device, when the article registration device suspends a transaction, and the settlement device resumes the transaction;

FIG. 19 is a transaction process flowchart of the settlement device, when the article registration device suspends a transaction, and the settlement device resumes the transaction;

FIG. 20A to FIG. 20C are screen transition diagrams of the settlement device, when the article registration device suspends a transaction, and the settlement device resumes the transaction;

FIG. 21 is a transaction process flowchart of the article registration device, when the settlement device suspends a transaction, and the article registration device resumes the transaction;

FIG. 22 is a transaction process flowchart of the settlement device, when the settlement device suspends a transaction, and the article registration device resumes the transaction;

FIG. 23A to FIG. 23G are screen transition diagrams of the customer-side display and the checker-side display of the article registration device, when the settlement device suspends a transaction, and the article registration device resumes the transaction; and

FIG. 24A to FIG. 24C and FIG. 25A and FIG. 25B are screen transition diagrams of a display unit of the settlement device, when the settlement device suspends a transaction, and the article registration device resumes the transaction.

### DETAILED DESCRIPTION OF THE PREFERRED EMBODIMENTS

A description will now be given, with reference to the drawings, of embodiments according to the present invention.

FIG. 1 is a diagram of a configuration of a transaction information management system (a transaction management system) according to an embodiment of the present invention.

A transaction information management system 1 according to the present embodiment is a POS (point-of-sale) system, which manages stock status of goods (articles of commerce), sales status thereof, etc. In the transaction information management system 1, terminal apparatuses 11 and a server (a management device) 13 can intercommunicate via a network 12. In this configuration, the terminal apparatuses 11 are so-called POS terminals.

Each of the terminal apparatuses 11 comprises an article registration device 21 and a settlement device 22. The article registration device 21 reads an article code from a bar code applied on an article of commerce. Additionally, the article registration device 21 comprises a multiple keyboard 32 (shown in FIG. 2) used for inputting an article code. In addition, the article registration device 21 according to the present embodiment is capable of controlling operations of a suspension/resumption function according to operations made to the multiple keyboard 32, as described hereinafter in detail.

Article information, such as particulars and a price of an article of commerce obtained by the article registration device 21 is supplied to the settlement device 22. The settlement device 22 creates transaction information, based on the article information supplied from the article registration device 21. Additionally, the settlement device 22 prints out a receipt, based on the created transaction information, and registers the created transaction information in the server 13 as a transaction log.

Next, a detailed description will be given of the terminal apparatus 11.

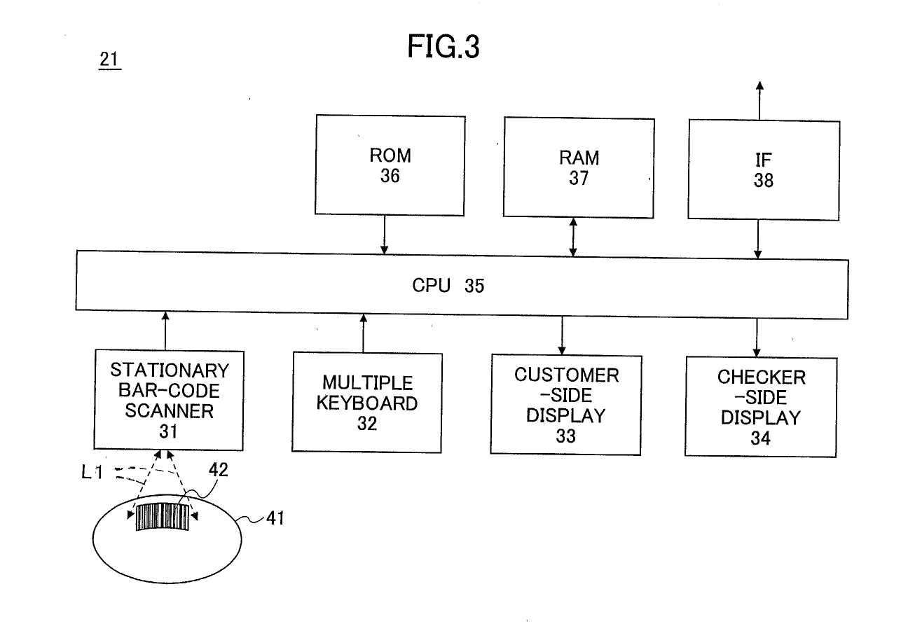

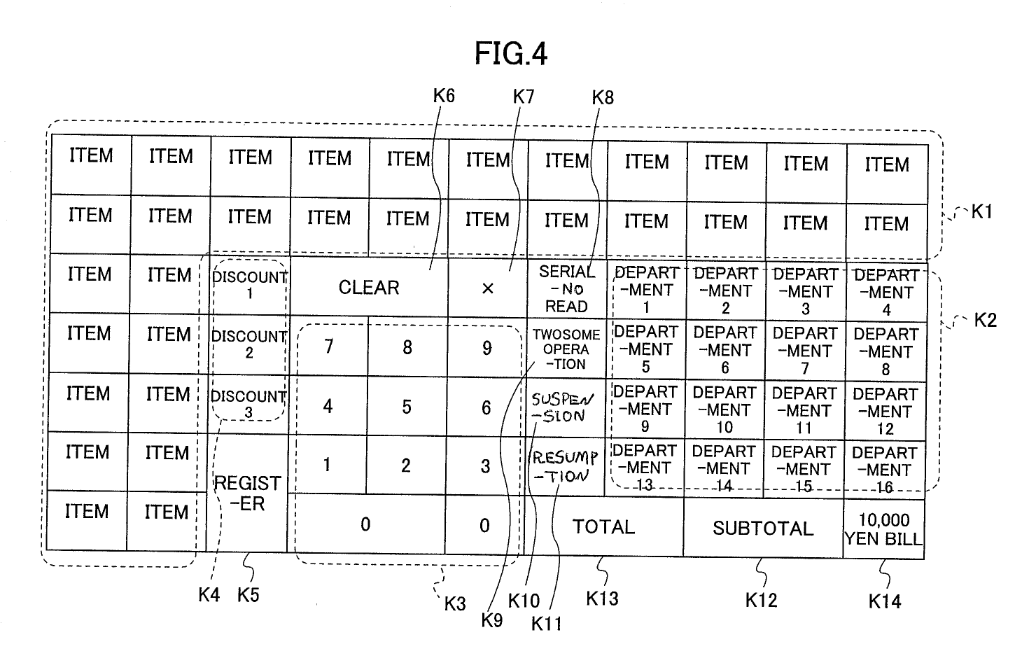

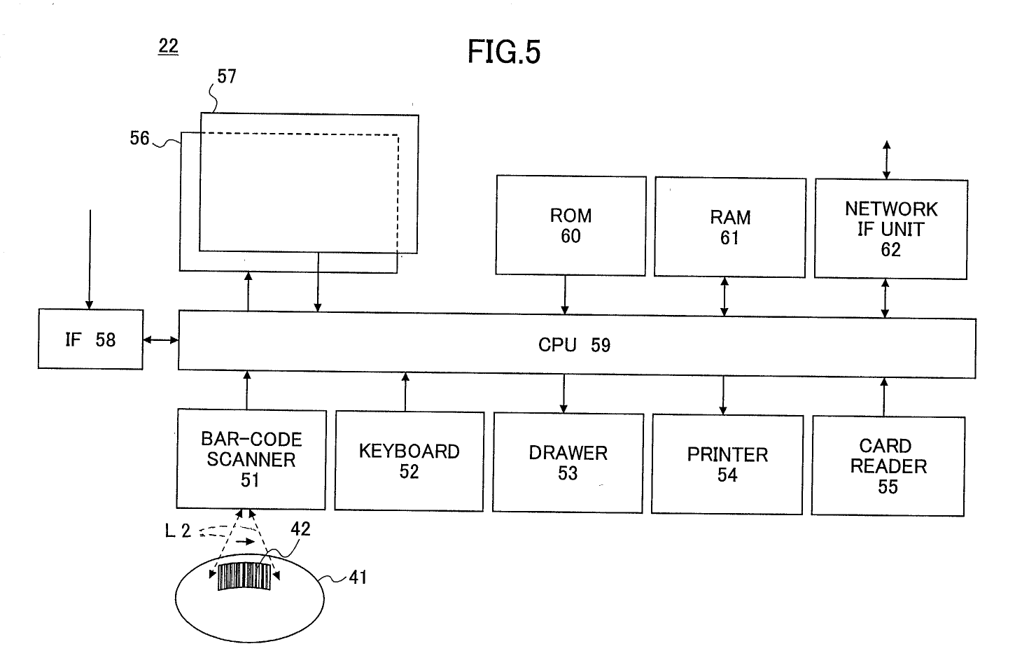

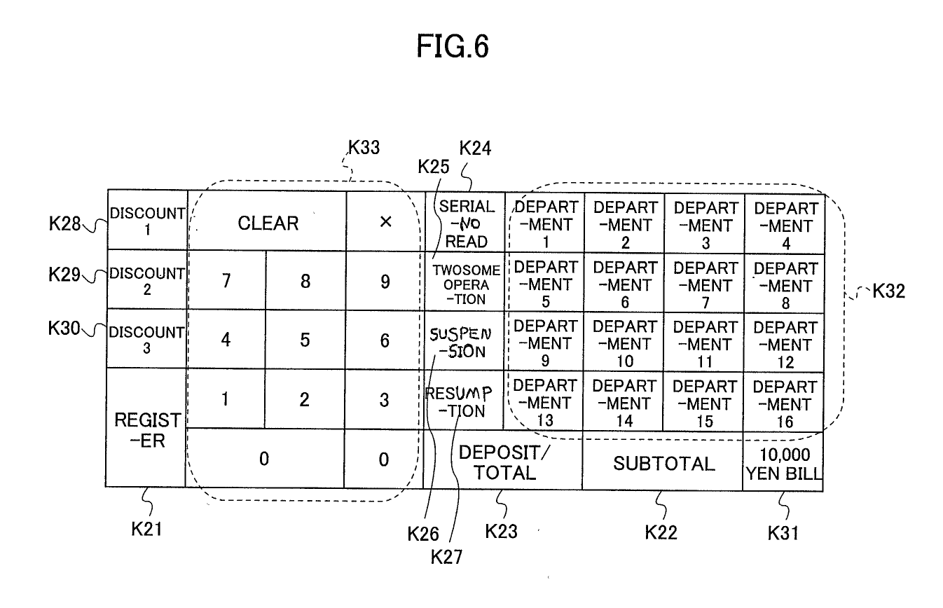

FIG. 2 is a perspective view of the terminal apparatus 11. FIG. 3 is a block diagram of the article registration device 21. FIG. 4 illustrates a key layout of the multiple keyboard 32 of the article registration device 21. FIG. 5 is a block diagram of the settlement device 22. FIG. 6 illustrates a key layout of a keyboard 52 of the settlement device 22.

The article registration device 21 is operated by a checker, in a twosome operation performed by the checker and a cashier, so as to perform an article registration operation. The article registration device 21 is mounted on a counter 40 as a peripheral device for the settlement device 22.

As shown in FIG. 2 and FIG. 3, the article registration device 21 comprises a stationary bar-code scanner 31, the multiple keyboard 32, a customer-side display 33, a checker-side display 34, a CPU (Central Processing Unit) 35, a ROM (Read Only Memory) 36, a RAM (Random Access Memory) 37, and an interface (IF) 38.

As shown in FIG. 3, the stationary bar-code scanner 31 projects a laser beam L1. The laser beam L1 projected from the stationary bar-code scanner 31 scans a bar code 42 applied on an article (of commerce) 41. The laser beam L1 reflected on the bar code 42 enters the stationary bar-code scanner 31. The stationary bar-code scanner 31 recognizes an article code from the laser beam L1 reflected on the bar code 42.

The multiple keyboard 32 has the key layout shown in FIG. 4, and mainly comprises an item-code input key group K1, a department-code input key group K2, a ten-key group K3, a discount key group K4, a register key K5, a clear key K6, a multiplication key K7, a serial-number read key K8, a twosome operation key K9, a suspension key K10, a resumption key K11, a subtotal key K12, a total key K13, and a ten-thousand yen bill key K14. At least the CPU 35 and the suspension key K10 form an article registration suspending unit. At least the CPU 35 and the resumption key K11 form an article registration resuming unit.

The multiple keyboard 32 allows a manual input of an article code, in which an article code is input by operating the item-code input key group K1, the department-code input key group K2, and the ten-key group K3.

The customer-side display 33 has a screen facing a customer, and displays a name and a unit price of a registered article, and a combined price, and a subtotal of registered articles. The customer can recognize the name, the unit price, the combined price and the subtotal by viewing the customer-side display 33. The checker-side display 34 has a screen facing a checker, and displays the name, the unit price, the combined price and the subtotal. The checker can recognize the name, the unit price, the combined price and the subtotal by viewing the checker-side display 34. Additionally, the checker can make sure whether or not the article is certainly registered.

The CPU 35 operates according to firmwaresumed in the ROM 36. For example, the CPU 35 transmits an article code read by the stationary bar-code scanner 31 to the settlement device 22, transmits information input from the multiple keyboard 32 to the settlement device 22, controls the display to the displays 33 and 34, and performs a process for receiving data from the settlement device 22. The RAM 37 is used as a working storage of the CPU 35. The interface 38 is used for interfacing the settlement device 22.

Next, a detailed description will be given of the settlement device 22.

The settlement device 22 is operated by a cashier in the above-mentioned twosome operation so as to settle articles registered by the article registration device 21. As shown in FIG. 2 and FIG. 5, the settlement device 22 comprises a bar-code scanner 51, the keyboard 52, a drawer 53, a printer 54, a card reader 55, a display unit 56, a touch panel 57, an interface (IF) 58, a CPU 59, a ROM 60, a RAM 61, and a network interface (IF) unit 62.

As shown in FIG. 5, the bar-code scanner 51 projects a laser beam L2 so as to scan the bar code 42 applied on the article 41. Then, the bar-code scanner 51 detects a light corresponding to a pattern of the bar code 42 reflected on the bar code 42 so as to read the bar code 42. In addition, operating the keyboard 52 enables various instructions for an article registration, a discount, a subtotal, a serial number reading, and also enables an input of a department code, etc.

As shown in FIG. 6, the keyboard 52 comprises a register key K21, a subtotal key K22, a deposit/total key K23, a serial-number read key K24, a twosome operation (mode set) key K25, a suspension key K26, a resumption key K27, discount keys K28 to K30, a ten-thousand yen bill key K31, a department-code input key group K32, and a ten-key group K33. At least the CPU 59 and the suspension key K26 form a settlement suspending unit. At least the CPU 59 and the resumption key K27 form a settlement resuming unit.

The register key K21 is used for starting a process of registering an article. The subtotal key K22 is used for ordering a calculation of a subtotal. The deposit/total key K23 is used for ordering a calculation of a total, a registration of a transaction log, and an issuance of a receipt. The serial-number read key K24 is used for ordering a start of a process of reading and correcting the transaction information already registered in the server 13. The twosome operation key K25 is used for ordering a start of the twosome operation in which a checker and a cashier perform an article registration and a settlement. The suspension key K26 is used for ordering a suspension of a transaction. The resumption key K27 is used for ordering a resumption of the suspended transaction. The discount keys K28 to K30 are used for ordering a discount from a price of a registered article. The ten-thousand yen bill key K31 is operated upon receiving a ten-thousand yen bill. The department-code input key group K32 comprises a plurality of keys used for inputting a department code. The ten-key group K33 comprises ten numeric keys, a multiplication key, and so forth, which are used for registering a plurality of identical articles, for example.

The drawer 53 contains cash, and is drawn out so as to enable a receipt and a payout of cash upon payment for an article of commerce. The printer 54 prints out a receipt for one transaction when the deposit/total key K23 is pressed down. The display unit 56 comprises a liquid crystal display panel and so forth, and displays such information as a unit price of a registered article and a subtotal of registered articles. The touch panel 57 comprises a touch panel so as to enable similar input operations to those of the keyboard 52.

The interface 58 is connected to the interface 38 of the article registration device 21 so as to interface therewith. The CPU 59 operates according to firmware programs stored in the ROM 60. For example, the CPU 59 communicates with the server 13 from the network interface unit 62 via the network 12 so as to perform various processes, such as a PLU (Price Look Up) process, a transaction information registration process, and processes for suspending/resuming a transaction, as described hereinafter. The RAM 61 is used as a working storage of the CPU 59. The network interface unit 62 is used for controlling a communication with the server 13 via the network 12.

Next, a description will be given of a configuration of the server 13.

FIG. 7 is a block diagram of the server 13.

The server 13 comprises a network interface (IF) unit 71, a CPU 72, a ROM 73, a RAM 74, and a HDD (Hard Disk Drive) 75. The network interface unit 71 is connected to the network 12 so as to control a communication with the settlement device 22. The CPU 72 operates according to programs and data stored in the ROM 73 and the HDD 75. The HDD 75 comprises at least a program domain 81, a PLU (Price Look Up) master database domain 82, a transaction log database domain 83, and a suspension database domain 84.

The program domain 81 stores the programs executed by the CPU 72. The PLU master database domain 82 stores article information, such as a unit price of an article of commerce.

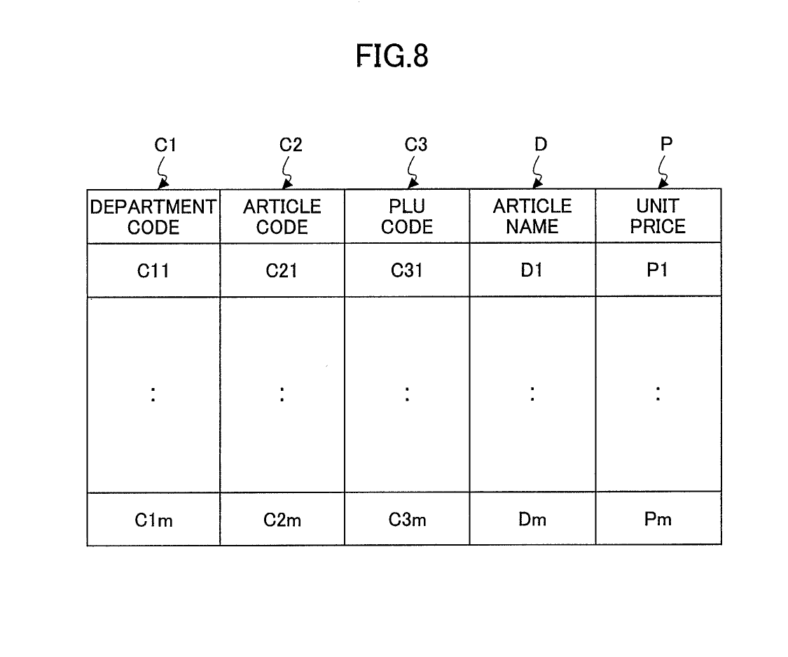

FIG. 8 illustrates a data configuration in the PLU master database domain 82.

The PLU master database domain 82 includes a department code C1, an article code C2, a PLU code C3, an article name D, a unit price P, on an individual article basis, in the form of a database. The department code C1 is used for identifying a department that deals with the article. The article code C2 is used for identifying the article. The PLU code C3 is used for identifying a price of the article. The article name D is a name of the article. The unit price P is a unit price of the article. For example, when the terminal apparatus 11 refers to the PLU master database domain 82 by an article code C21, the terminal apparatus 11 can obtain a department code C1, a PLU code C31, an article name D1, a unit price P1 corresponding to the article code C21. Thus, the terminal apparatus 11 can recognize the department code, the PLU code, the article name, and the unit price of the article, according to the result of the reference to the PLU 5 master database domain 82, so as to create transaction information.

The transaction log database domain 83 stores the transaction information created in the settlement device 22.

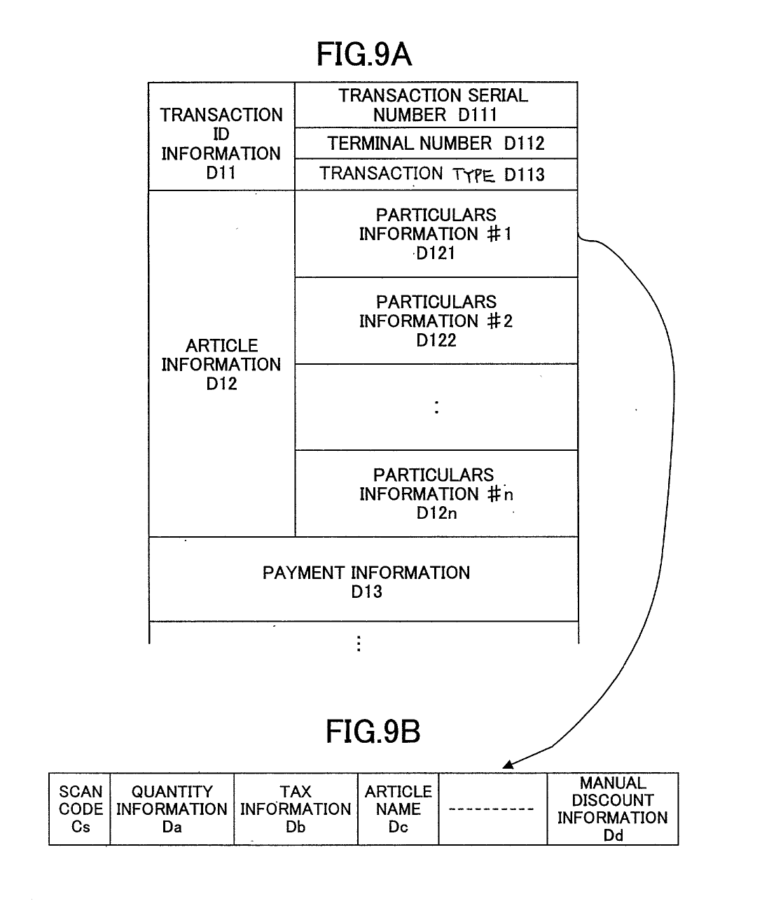

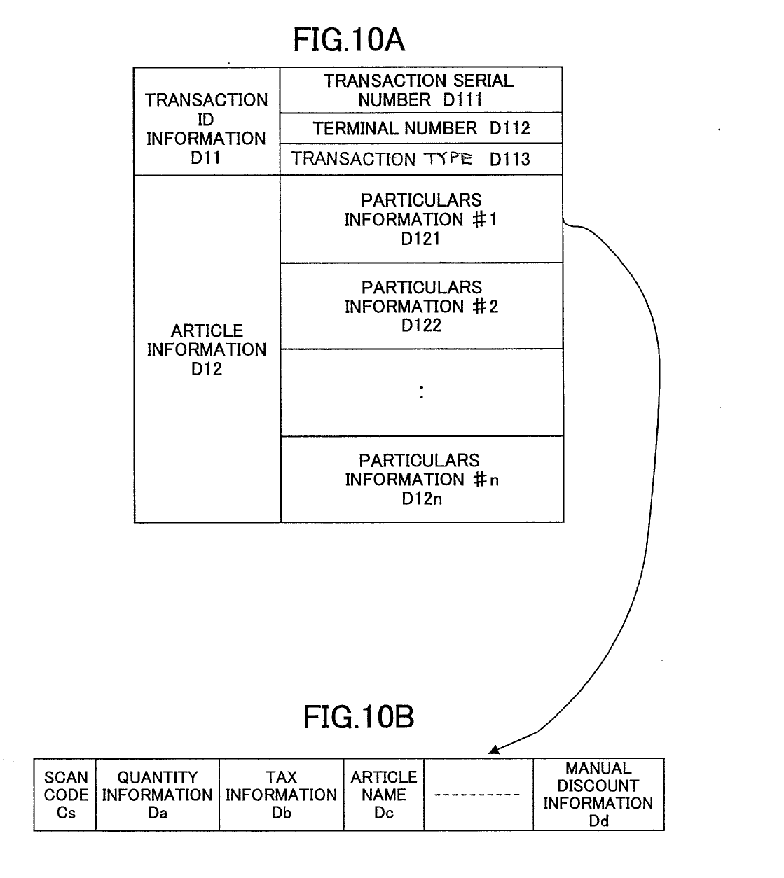

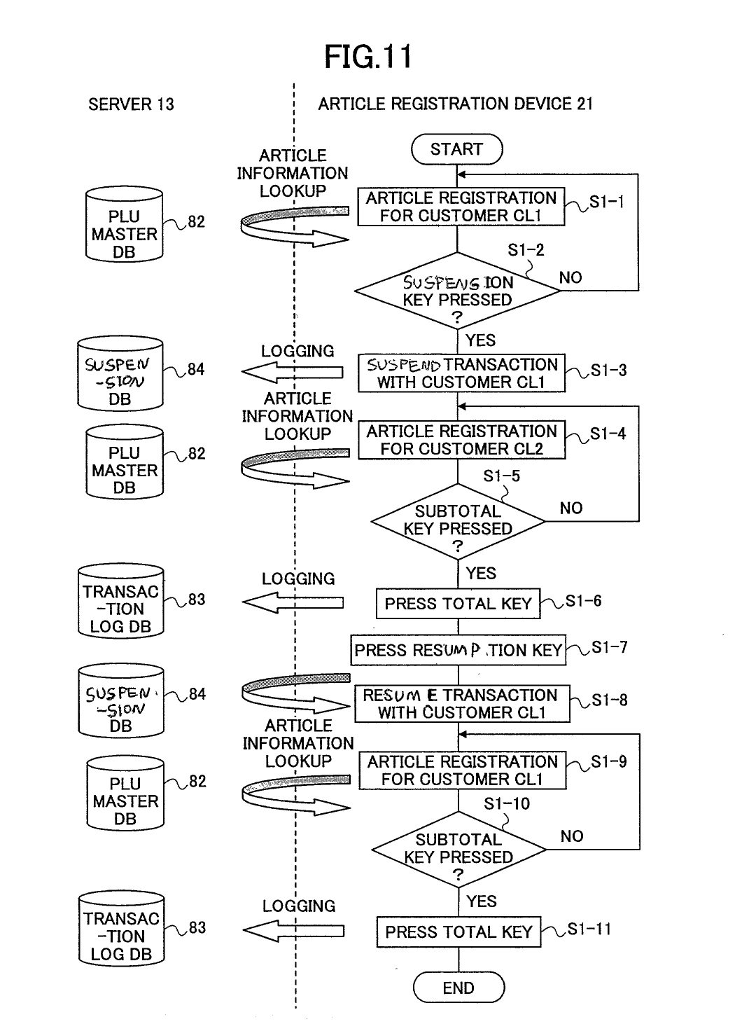

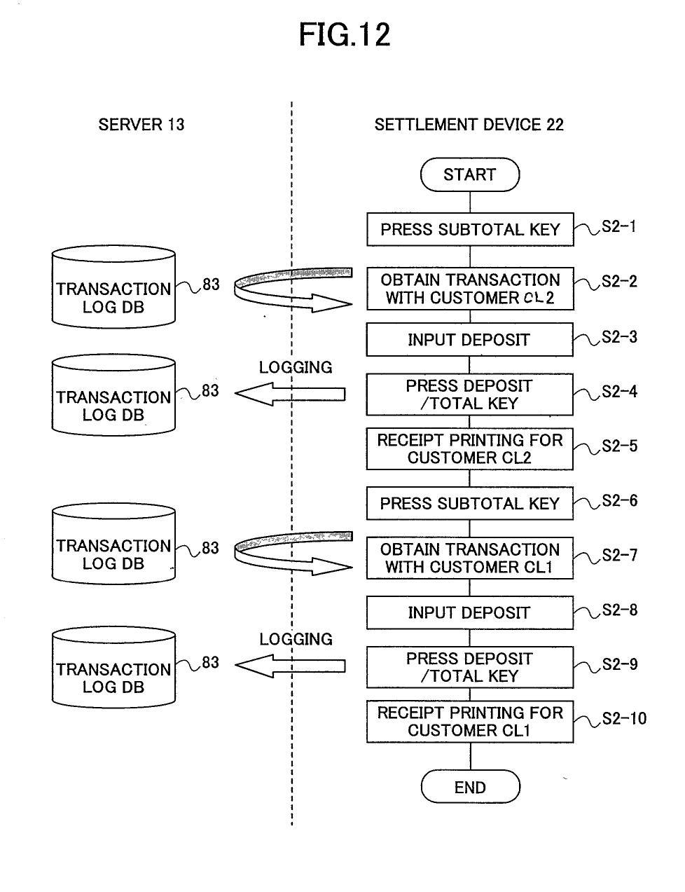

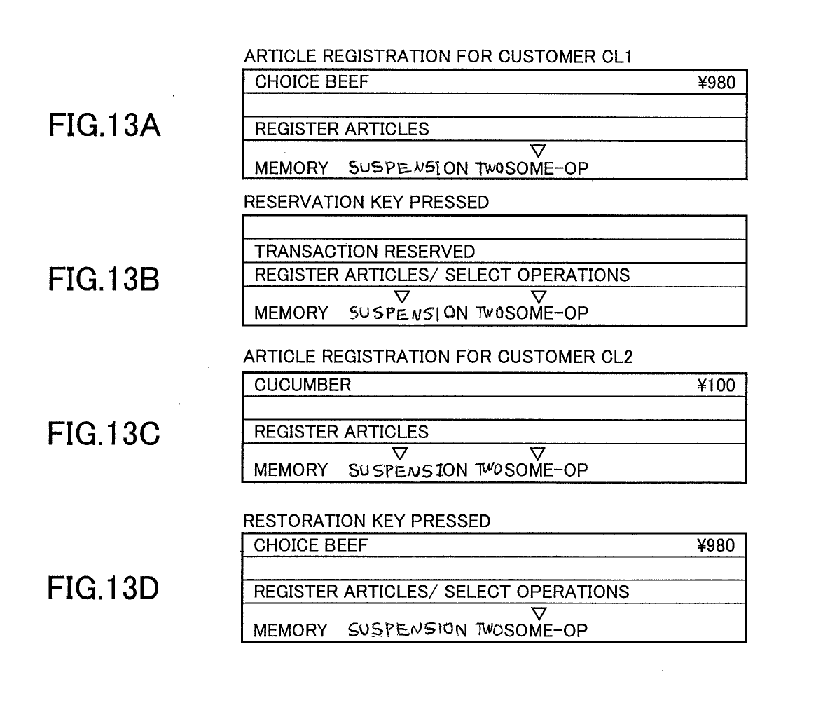

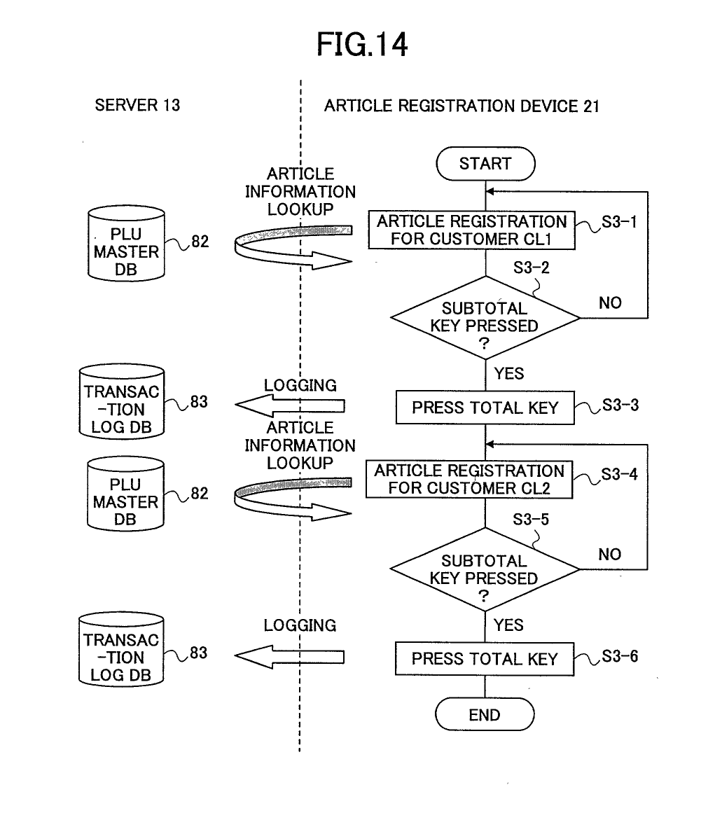

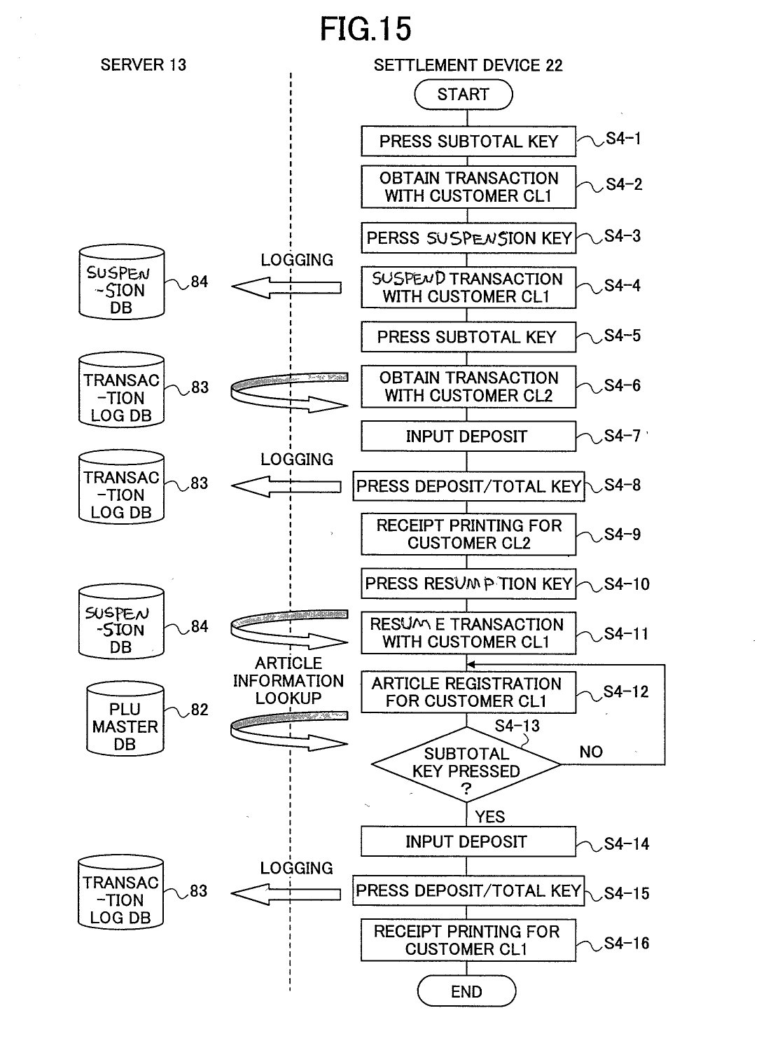

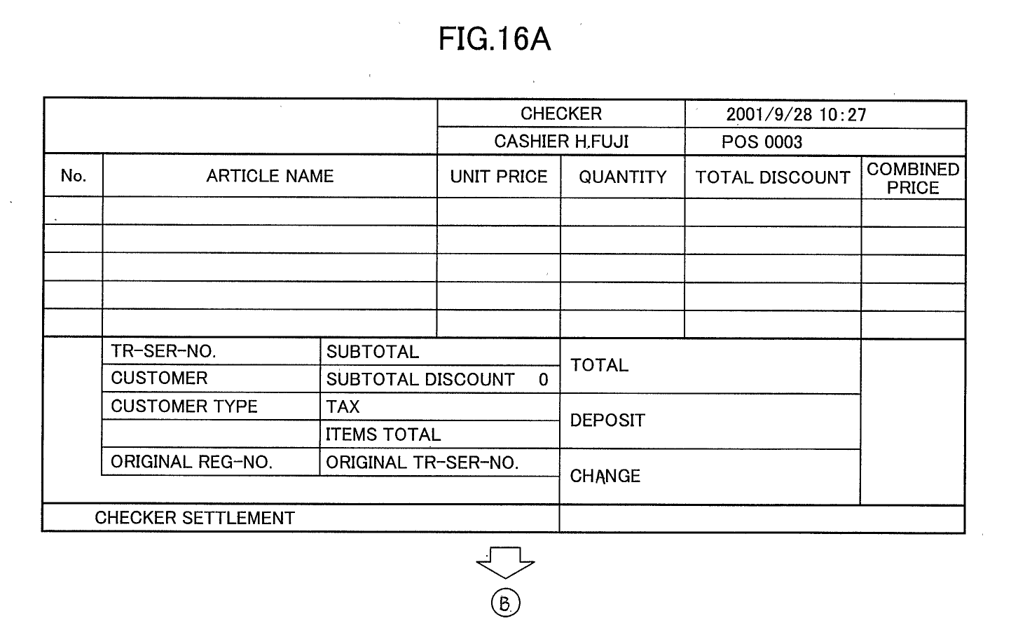

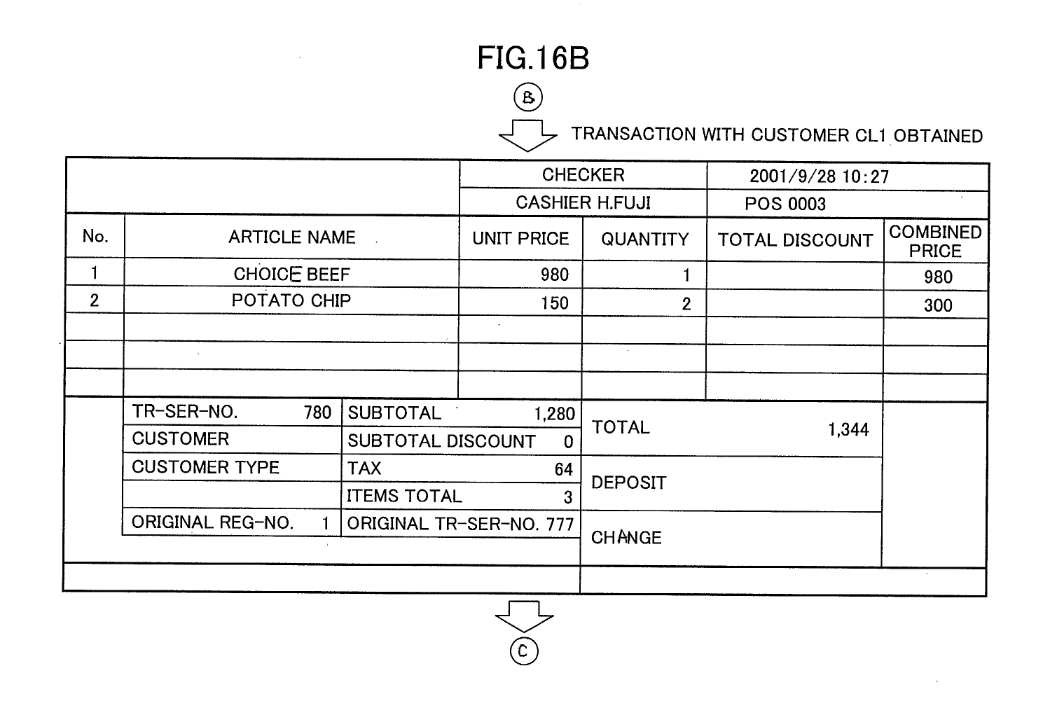

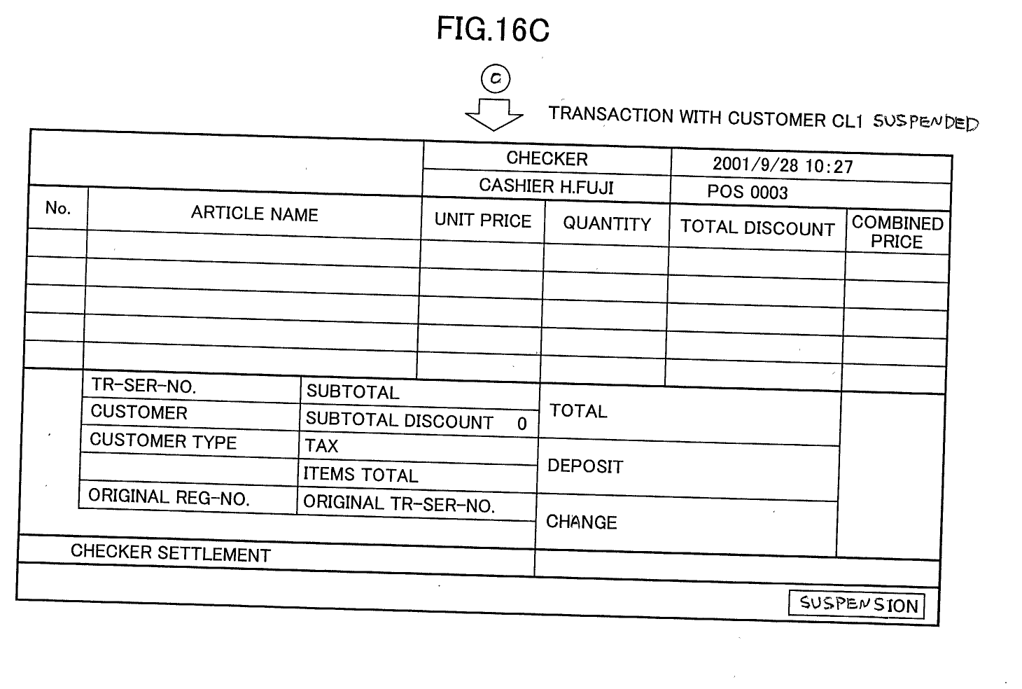

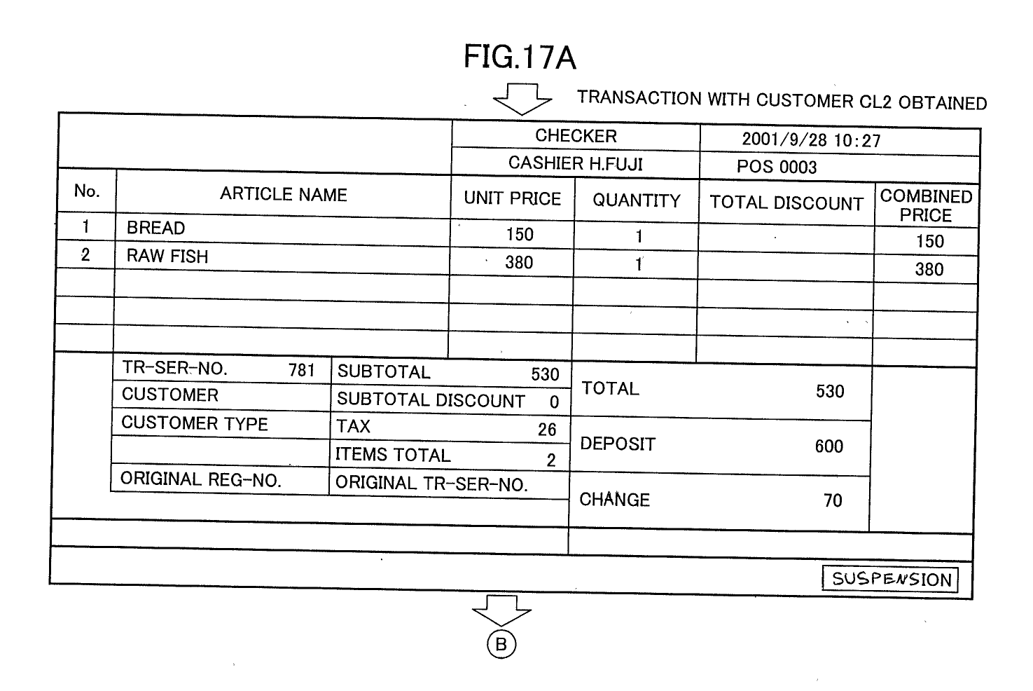

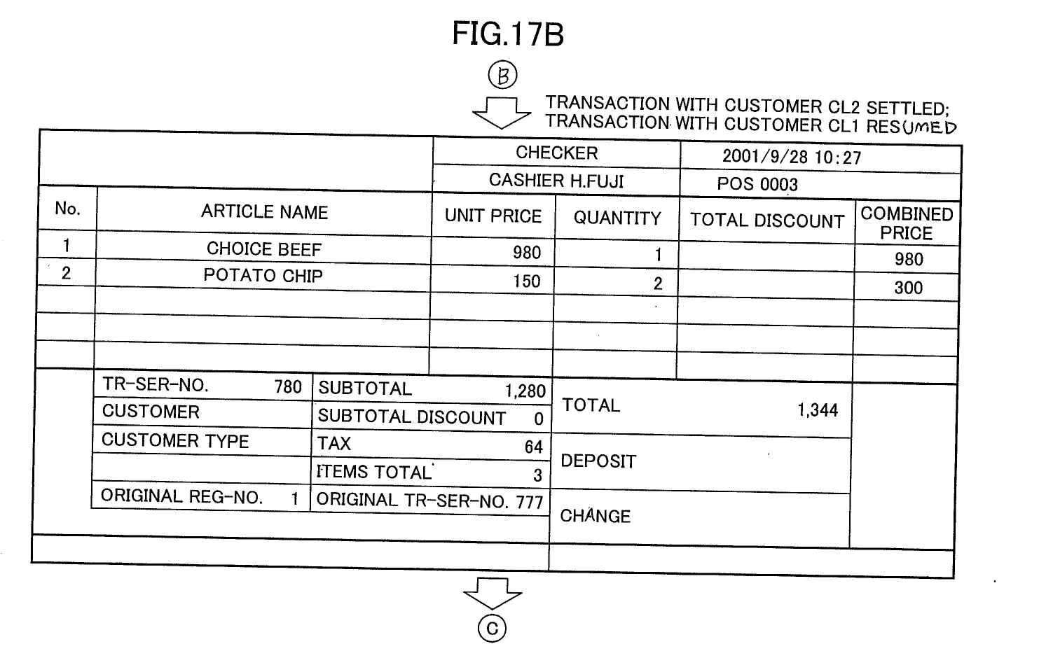

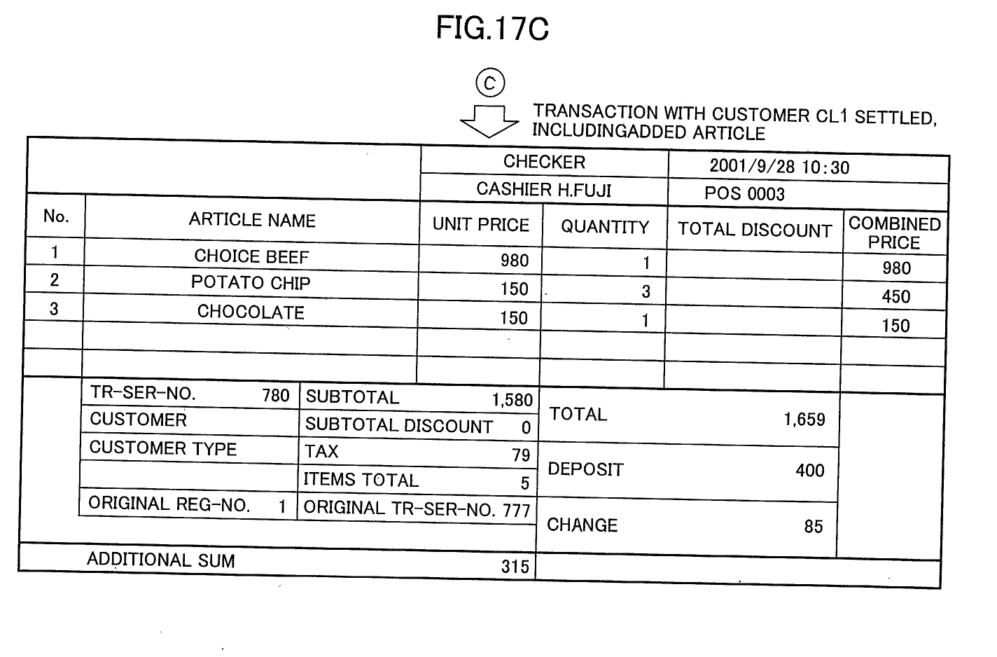

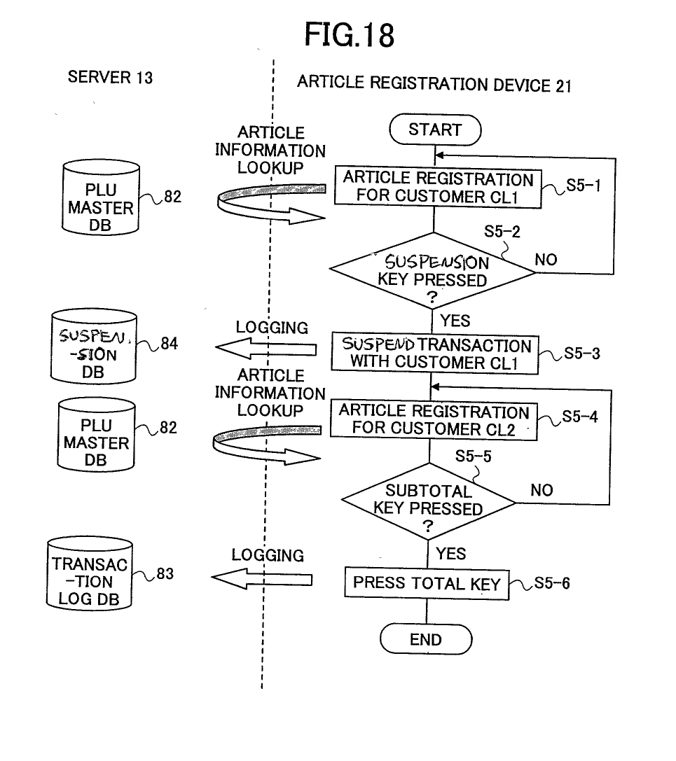

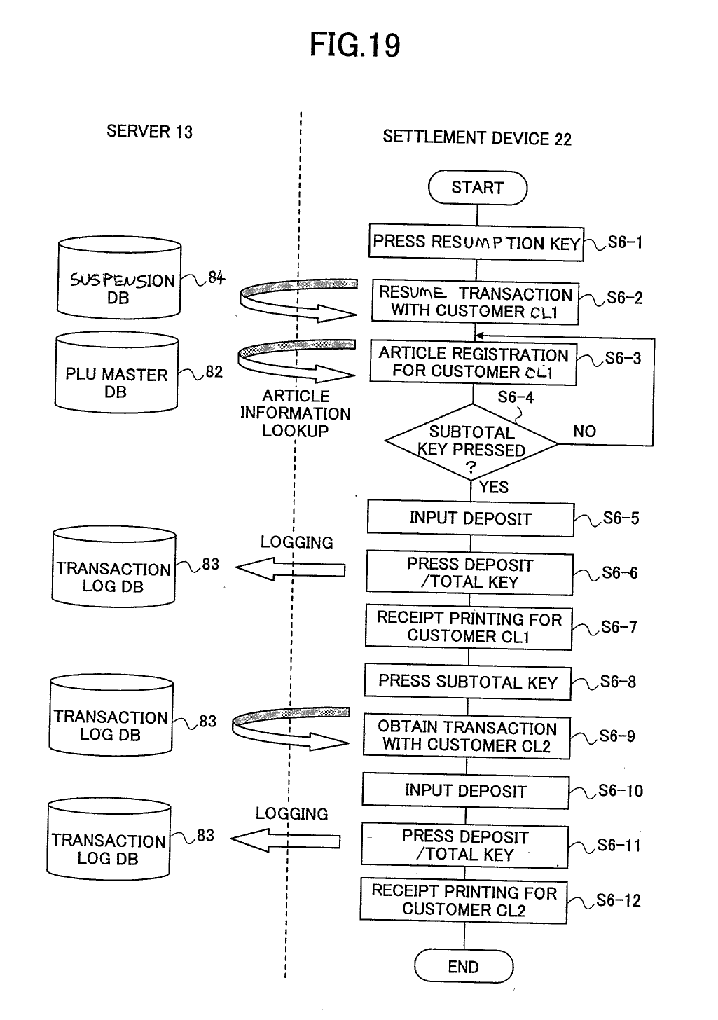

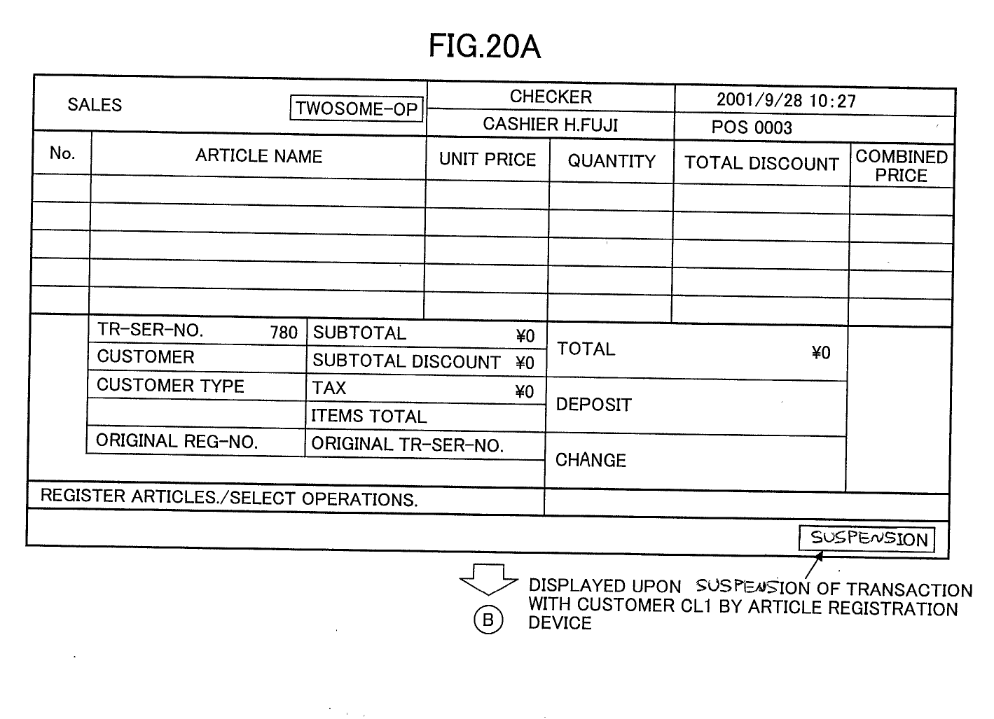

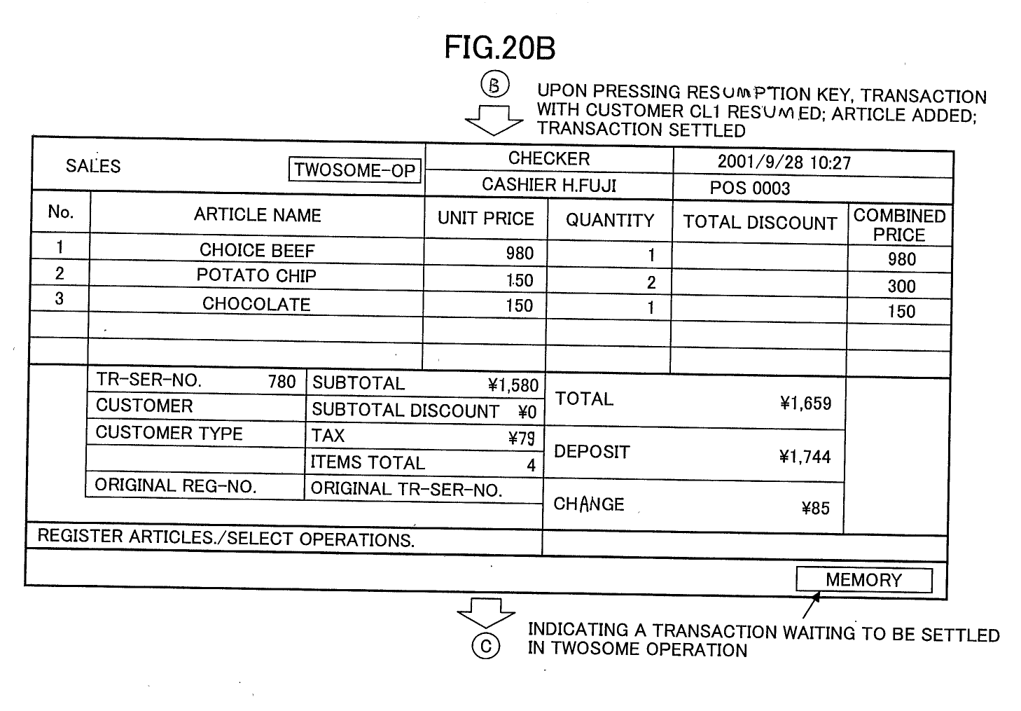

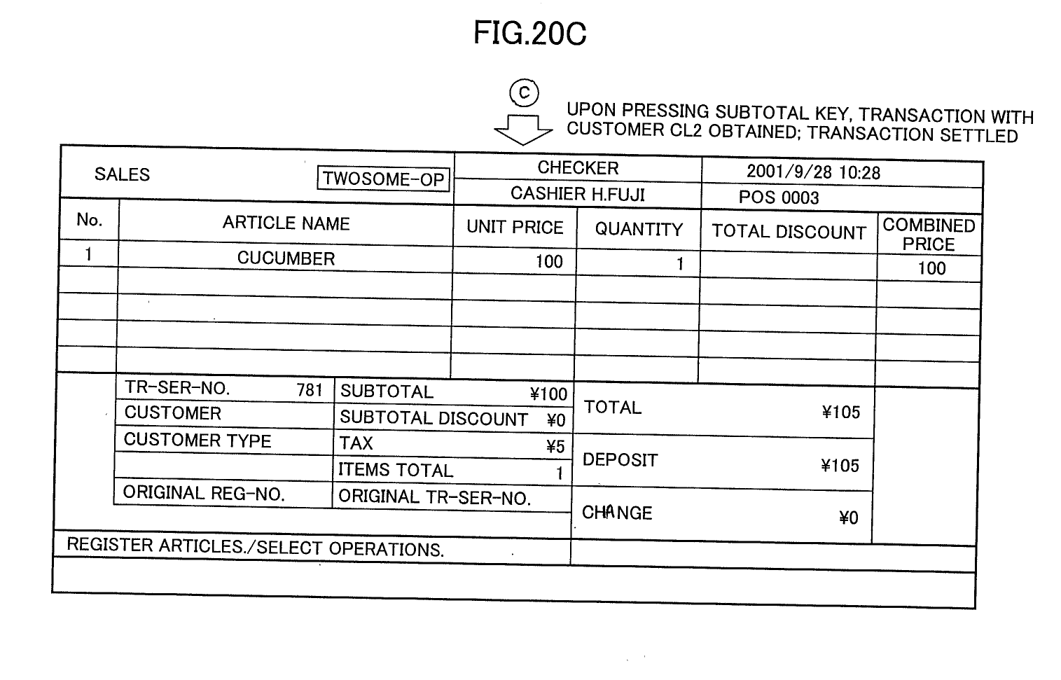

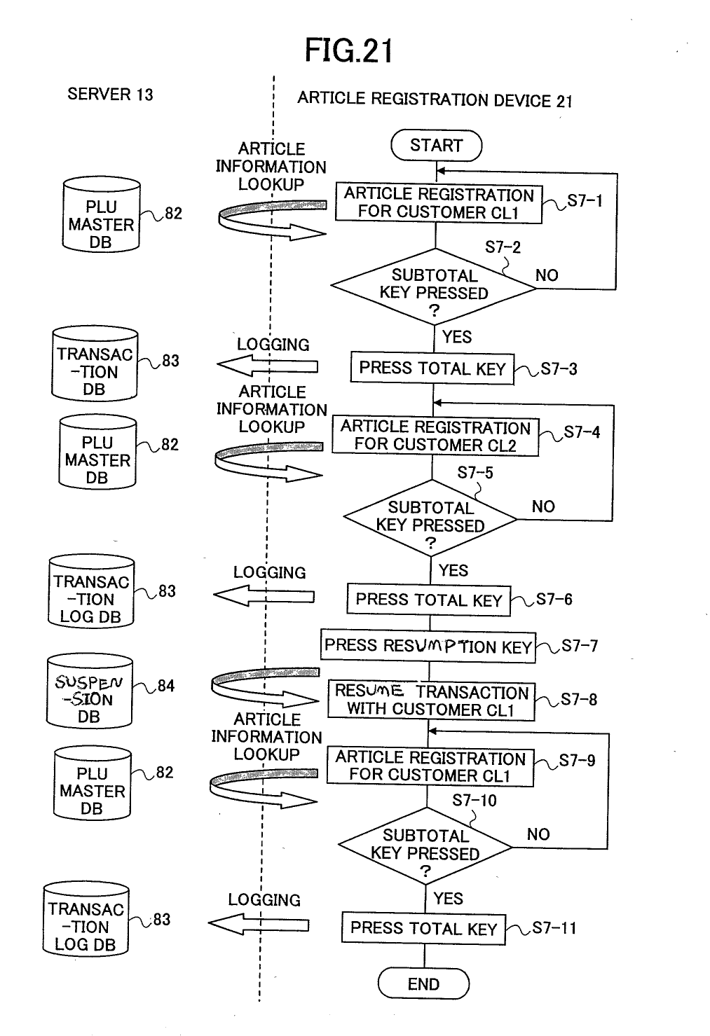

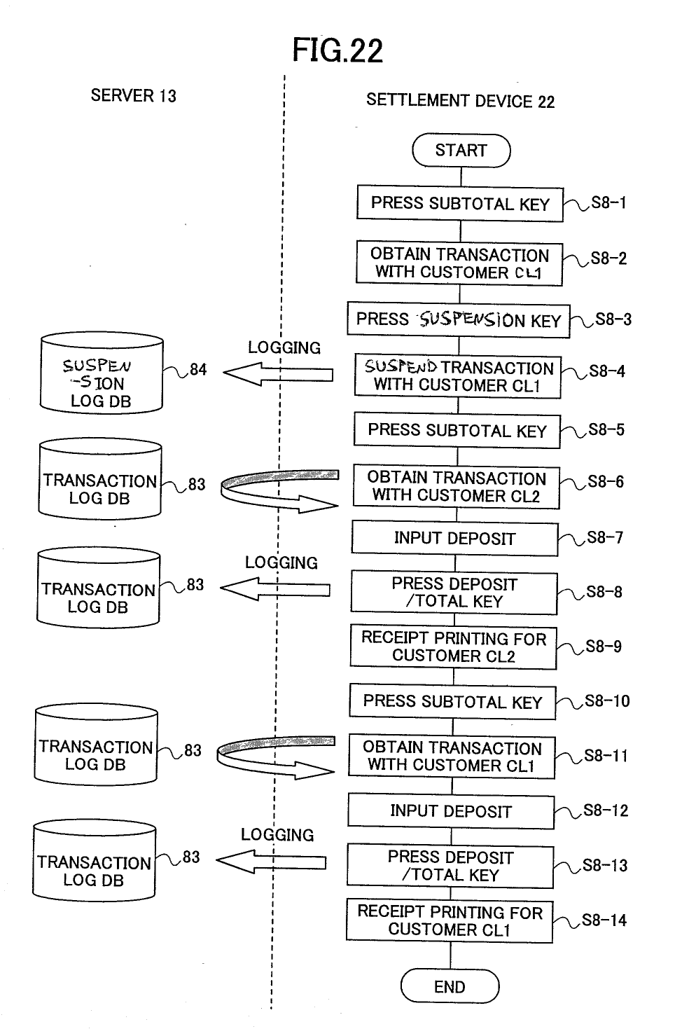

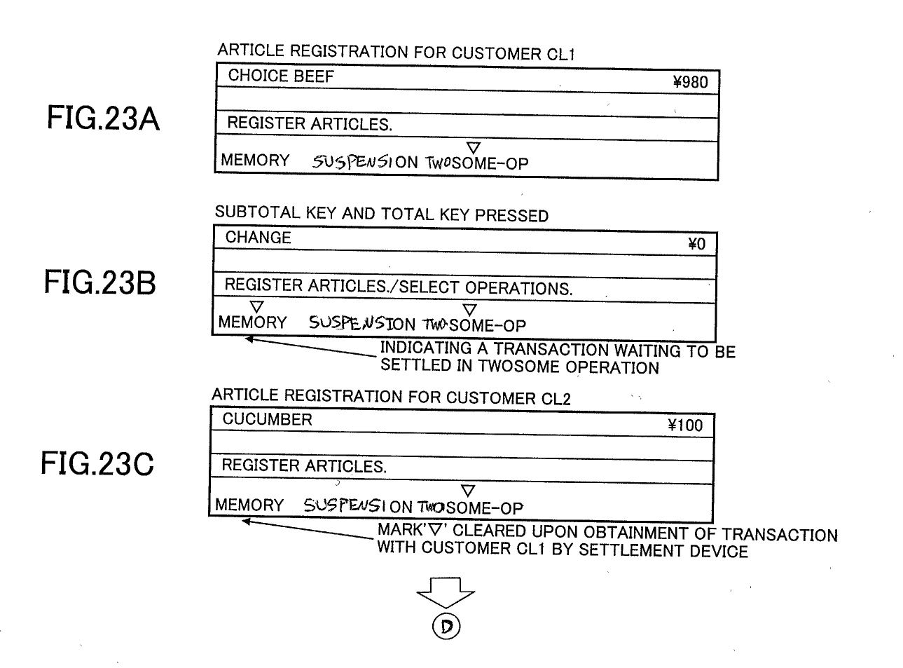

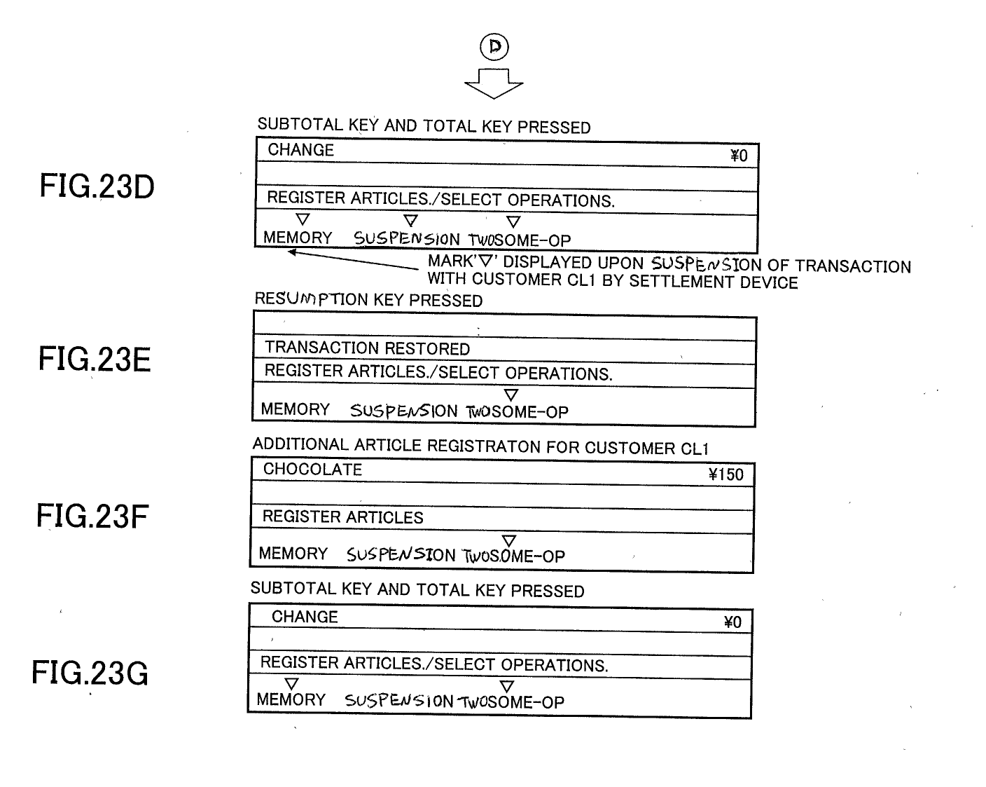

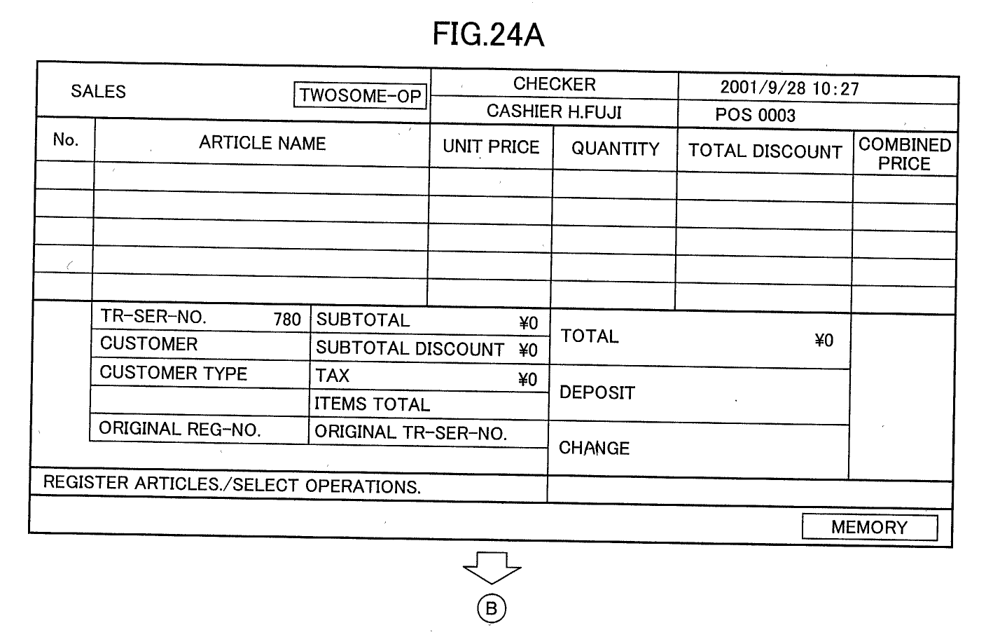

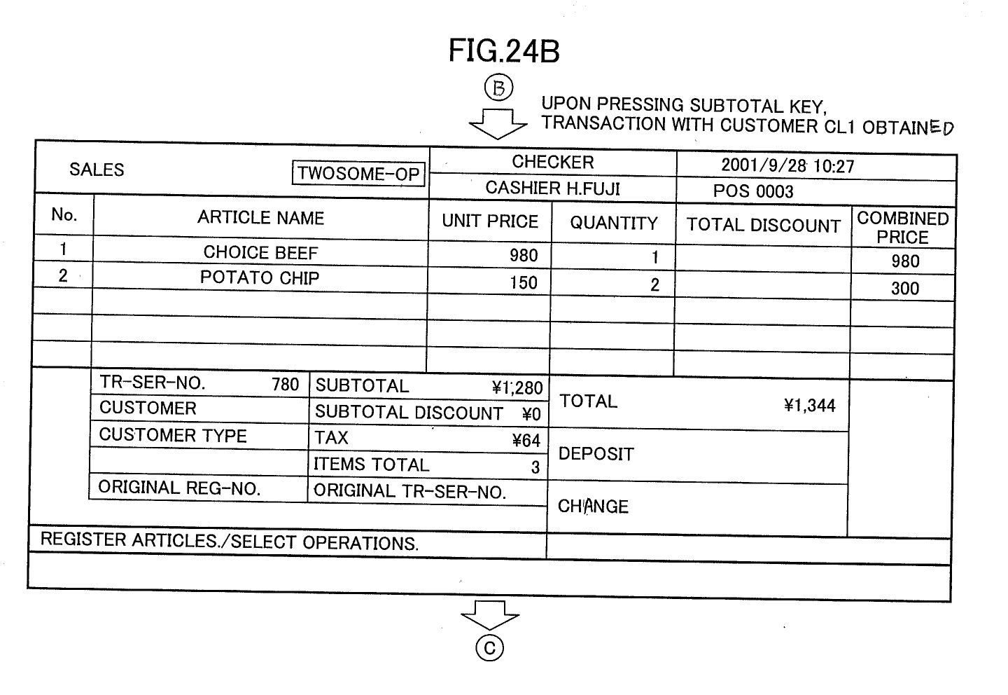

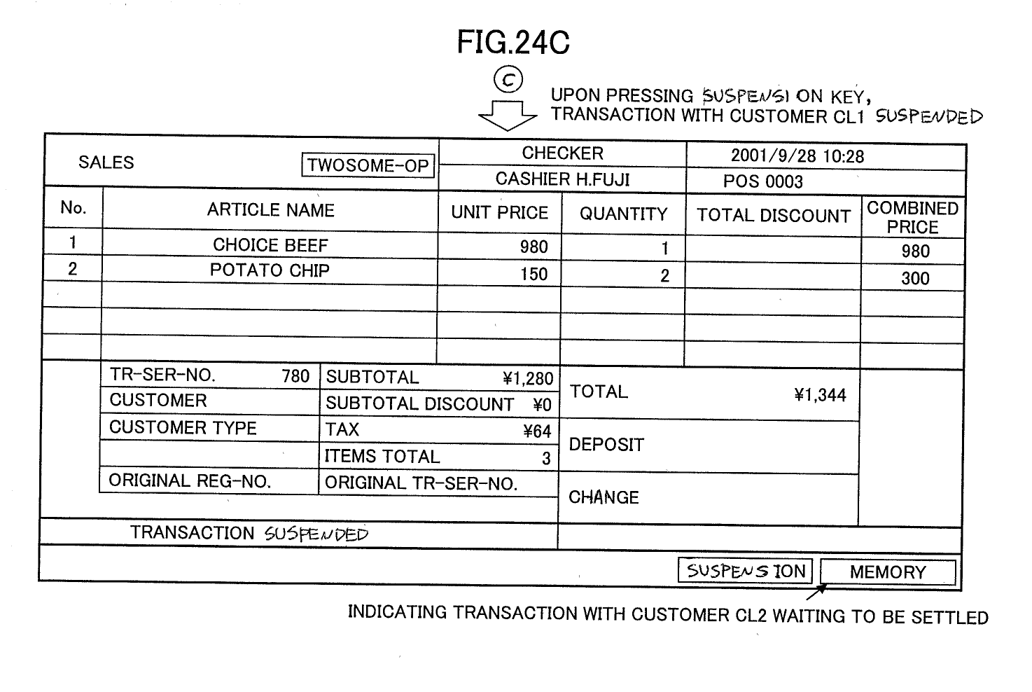

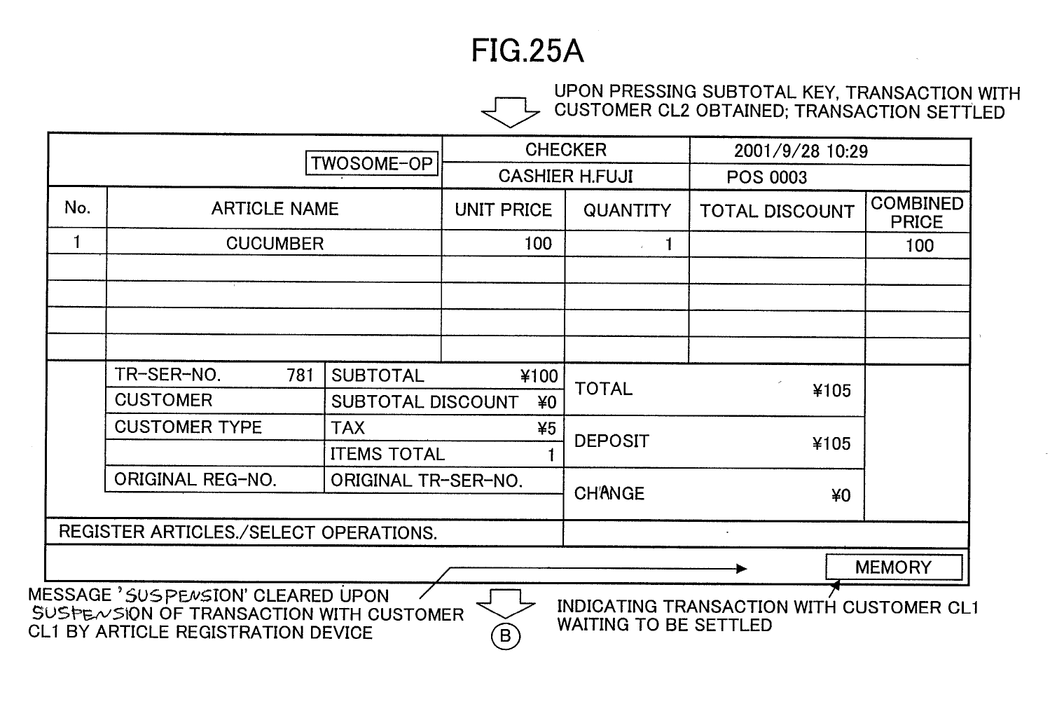

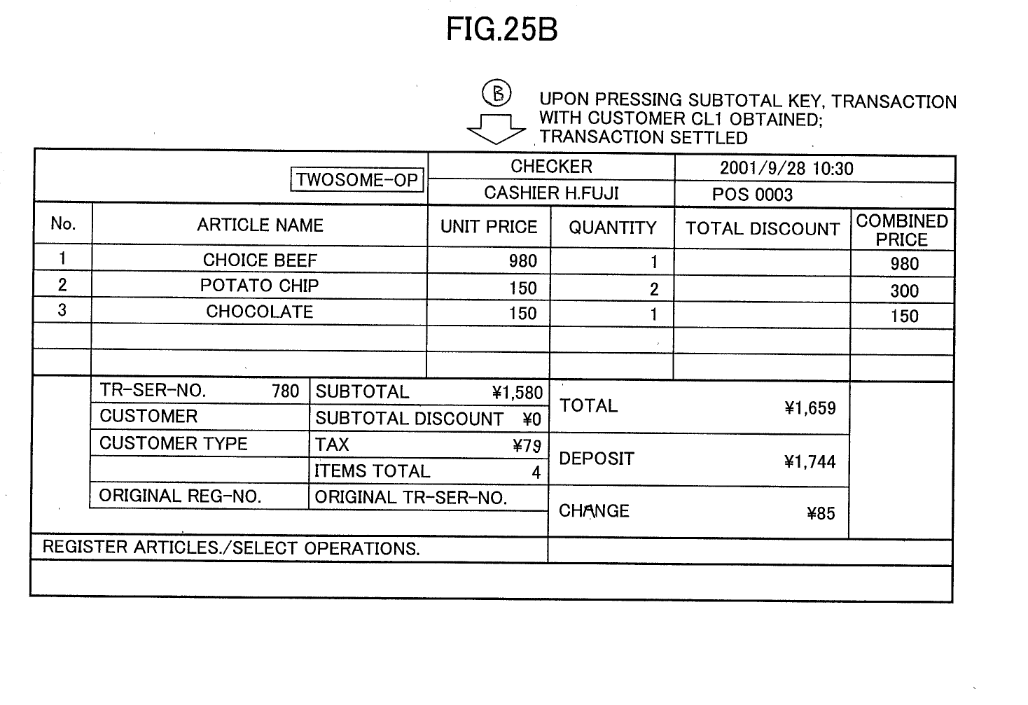

FIG. 9A illustrates a data configuration in the transaction log database domain 83.

The transaction log database domain 83 stores transaction identification (ID) information D11, article information D12, and payment 15 information D13 on an individual transaction basis.

The transaction identification information D11 is used for identifying the transaction, and includes a transaction serial number D111, a terminal number D112, and a transaction type D113.

The transaction serial number D111 is given in series to each transaction log when the transaction log is created. The transaction serial number D111 is printed on the receipt. Accordingly, by inputting the transaction serial number D111 from the terminal apparatus 11, and searching the transaction log database domain 83 in the server 13 for the input transaction serial number D111, necessary transaction information can be obtained.

The terminal number D112 is used for identifying the terminal apparatus 11 that has settled the article. The transaction type D113 is used for identifying a type of the transaction, such as a normal settlement transaction, and an additional settlement transaction.

The article information D12 contains particulars information D121 to D12n of each article. FIG. 9B illustrates a data configuration of the particulars information.

The particulars information D121 includes a scan code Cs, quantity information Da, tax information Db, an article name Dc, a manual discount information Dd, and so forth. The scan code Cs is recognized when scanned by the bar-code scanner 31 or 51. The unit price of the corresponding article can be obtained by searching the PLU master database domain 82, based on the above-mentioned scan code Cs.

The quantity information Da indicates a quantity of identical articles in one transaction. The tax information Db indicates a tax amount levied on the transaction. The manual discount information Dd indicates an amount of discount corresponding to the discount key group K4 of the multiple keyboard 32 or the discount keys K28 to K30 of the keyboard 52.

The payment information D13 regards a mode of payment, such as by cash, or by card. In addition, when the mode of payment is by cash, the payment information D13 includes information concerning an amount of money received and an amount of change. When the mode of payment is by card, the payment information D13 includes information concerning a card number and a number of payments.

The suspension database domain 84 stores suspended transaction information.

FIG. 10A and FIG. 10B illustrate a data configuration in the suspension database domain 84.

The suspension database domain 84 has the same data configuration as the transaction log database domain 83, except for the payment information D13, and thus, stores the transaction identification information D11, and the article information D12. The suspension database domain 84 stores article information registered thitherto in one transaction.

Hereinbelow, descriptions will be given of operations of the transaction information management system 1 according to the present embodiment.

Firstly, a description will be given of operations when the article registration device 21 performs suspension/resumption.

FIG. 11 is a transaction process flowchart of the article registration device 21, when the article registration device 21 performs suspension/resumption. FIG. 12 is a transaction process flowchart of the settlement device 22, when the article registration device 21 performs suspension/resumption. FIG. 13A to FIG. 13D are screen transition diagrams of the customer-side display 33 and the checker-side display 34, when the article registration device 21 performs suspension/resumption.

In step S1-1 shown in FIG. 11, a checker registers an article of commerce in a transaction with a customer CL1 by operating the article registration device 21. Specifically, the checker registers the article 41 by facing the bar code 42 of the article 41 toward the stationary bar-code scanner 31. When the stationary bar-code scanner 31 reads the bar code 42 so as to recognize an article code thereof, the article code is registered in the settlement device 22. The settlement device 22 accesses the server 13 via the network 12, and refers to the PLU master database domain 82 so as to look up and obtain information including a unit price corresponding to the article code. The settlement device 22 creates and stores article information based on the information including the unit price obtained as a result of the reference to the PLU master database domain 82. At this point, the checker-side display 34 of the article registration device 21 displays a name and a combined price of the registered article, as shown in FIG. 13A. Additionally, since the above-mentioned twosome operation is performed in the present embodiment, the checker-side display 34 displays “∇” above “TWOSOME-OP”, as shown in FIG. 13A, so that the checker recognizes that the twosome operation is performed.

In the course of the step S1-1 in which the checker registers the article for the customer CL1, when the customer CL1 requests the present transaction to be suspended so as to add articles or exchange articles, the checker presses the suspension key K10 of the multiple keyboard 32 in step S1-2 such that the transaction with the customer CL1 is suspended in step S1-3. In the step S1-3, the article information registered by the article registration device 21 and stored in the settlement device 22 is stored (logged) in the suspension database domain 84 of the server 13 via the network 12. At this point, the checker-side display 34 displays “∇” above “SUSPENSION”, as shown in FIG. 13B, so as to indicate that there is a suspended transaction.

Suspending the transaction with the customer CL1 in the step S1-3 enables a transaction with a next customer CL2. In step S1-4, the checker registers an article of commerce in the transaction with the customer CL2 in the same manner as with the customer CL1 by the stationary bar-code scanner 31 reading the bar code 42 of the article 41 so as to obtain an article code thereof. The obtained article code is supplied to the settlement device 22. The settlement device 22 refers to the PLU master database domain 82 of the server 13 so as to create article information. At this point, the checker-side display 34 of the article registration device 21 displays the article information of the article registered in the transaction with the customer CL2, as shown in FIG. 13C. Also at this point, since the transaction with the customer CL1 is suspended, the checker-side display 34 displays “∇” above “SUSPENSION”, as shown in FIG. 13C, so that it can be recognized that the transaction with the customer CL1 is suspended.

The subtotal key K12 is pressed down upon completion of the article registration for the customer CL2 in step S1-5. Then, when the total key K13 is pressed down in step S1-6, transaction information is created based on the article information of the customer CL2, and is supplied to the server 13. The server 13 stores (logs) the transaction information in the transaction log database domain 83.

At this point, in order to resume the transaction with the customer CL1, the resumption key K11 is pressed down in step S1-7. When the resumption key K11 is pressed down, the article information of the customer CL1 is obtained (looked up) from the suspension database domain 84 of the server 13, and is resumed in the settlement device 22 in step S1-8. At this point, the checker-side display 34 of the article registration device 21 displays the article information of the article registered in the transaction with the customer CL1, as shown in FIG. 13D, without “∇” above “SUSPENSION”.

When the transaction with the customer CL1 is resumed in the step S1-8, an additional article can be registered in step S1-9. When the checker finishes registering additional articles, the checker presses down the subtotal key K12 in step S1-10. Then, the checker presses down the total key K13 in step S1-11. When the total key K13 is pressed down in the step S1-11, transaction information is created based on the registered article information, and is stored (logged) in the transaction log database domain 83 of the server 13. The settlement device 22 performs an operation for settling the articles, based on the transaction information stored in the transaction log database domain 83 of the server 13.

Next, a description will be given of operations of the settlement device 22, when the article registration device 21 performs suspension/resumption.

After the total key K13 of the multiple keyboard 32 of the article registration device 21 is pressed down in the step S1-6 upon completion of the article registration for the customer CL2, and when the subtotal key K22 of the keyboard 52 of the settlement device 22 is pressed down in step S2-1 shown in FIG. 12, the settlement device 22 obtains the transaction information of the customer CL2 from the transaction log database domain 83 of the server 13 in step S2-2. The settlement device 22 displays the obtained transaction information on the display unit 56.

When a deposit received from the customer CL2 is input in step S2-3, and the deposit/total key K23 is pressed down in step S2-4, the settlement device 22 adds payment information to the transaction information, and stores (logs) the transaction information in the transaction log database domain 83 of the server 13. Additionally, when the deposit/total key K23 is pressed down in the step S2-4, a receipt showing the transaction information of the customer CL2 is printed out from the printer 54 in step S2-5.

Then, after the total key K13 of the multiple keyboard 32 of the article registration device 21 is pressed down in the step S1-11 upon completion of the article registration for the customer CL1, and when the subtotal key K22 of the keyboard 52 of the settlement device 22 is pressed down in step S2-6, the settlement device 22 obtains the transaction information of the customer CL1 from the transaction log database domain 83 of the server 13 in step S2-7. The settlement device 22 displays the obtained transaction information on the display unit 56.

When a deposit received from the customer CL1 is input in step S2-8, and the deposit/total key K23 is pressed down in step S2-9, the settlement device 22 adds payment information to the transaction information, and stores (logs) the transaction information in the transaction log database domain 83 of the server 13. Additionally, when the deposit/total key K23 is pressed down in the step S2-9, a receipt showing the transaction information of the customer CL1 is printed out from the printer 54 in step S2-10.

As described above, when a transaction is suspended by the article registration device 21, and is resumed in the settlement device 22, the transaction can be settled by a normal settling operation.

Secondly, a description will be given of operations when the settlement device 22 suspends a transaction and resumes the transaction.

FIG. 14 is a transaction process flowchart of the article registration device 21, when the settlement device 22 performs suspension/resumption. FIG. 15 is a transaction process flowchart of the settlement device 22, when the settlement device 22 performs suspension/resumption. FIG. 16A to FIG. 16C and FIG. 17A to FIG. 17C are screen transition diagrams of the settlement device 22, when the settlement device 22 performs suspension/resumption.

To begin with, a description will be given of operations of the article registration device 21. In step S3-1 shown in FIG. 14, an article code of an article purchased by the customer CL1 is registered by the stationary bar-code scanner 31 reading the bar code 42 of the article 41. The registered article code is supplied to the settlement device 22. The settlement device 22 refers to the PLU master database domain 82 of the server 13 so as to create article information including a department code and a unit price of the article.

In step S3-2, when the subtotal key K12 is pressed down, the article registration device 21 creates transaction information based on the article information of the article registered in the settlement device 22, completing an article registration for the customer CL1. When the total key K13 of the article registration device 21 is pressed down in step S3-3, the settlement device 22 stores the created transaction information in the transaction log database domain 83 of the server 13. Pressing down the total key K13 of the article registration device 21 enables a transaction with the next customer CL2.

In step S3-4, an article to be purchased in the transaction with the customer CL2 is registered by the article registration device 21. Then, when the subtotal key K12 is pressed down in step S3-5, the settlement device 22 creates transaction information based on the article information of the registered article. Subsequently, the total key K13 of the article registration device 21 is pressed down in step S3-6, the settlement device 22 stores the transaction information in the transaction log database domain 83 of the server 13.

As described above, the article registrations for the customer CL1 and the customer CL2 are performed in succession.

Next, a description will be given of operations of the settlement device 22.

Upon completing the article registration for the customer CL1 in the step S3-2, the display unit 56 of the settlement device 22 displays a message “CHECKER SETTLEMENT”, as shown in FIG. 16A. When the subtotal key K22 of the settlement device 22 is pressed down in step S4-1 shown in FIG. 15, the transaction information of the customer CL1 is obtained in step S4-2 such that the display unit 56 displays the article information of the articles to be purchased by the customer CL1, as shown in FIG. 16B.

Subsequently, when the suspension key K26 of the settlement device 22 is pressed down in step S4-3, the settlement device 22 stores the transaction information of the customer CL1 in the suspension database domain 84 in step S4-4; thereby, the transaction with the customer CL1 is suspended. When the transaction with the customer CL1 is suspended in the step S4-4, the display unit 56 displays a message “SUSPENSION”, as shown in FIG. 16C, which indicates that there is a suspended transaction.

Then, when the subtotal key K22 of the settlement device 22 is pressed down in step S4-5, the transaction information of the customer CL2 is obtained from the transaction log database domain 83 of the server 13 in step S4-6 so as to enable a settlement for the customer CL2. When a deposit received from the customer CL2 is input in step S4-7 as displayed in FIG. 17A, and the deposit/total key K23 is pressed down in step S4-8, payment information is created and is added to the transaction information, and the transaction information is stored again in the transaction log database domain 83 of the server 13, in the step S48. Further, a receipt is printed out in step S4-9.

Thus, the settlement for the customer CL2 is completed.

Then, when the resumption key K27 of the settlement device 22 is pressed down in step S4-10, the transaction information of the customer CL1 is resumed from the suspension database domain 84 of the server 13 to the settlement device 22 in step S4-11. Thereby, the transaction information of the customer CL1 is resumed on the display unit 56 of the settlement device 22, as shown in FIG. 17B.

Resuming the transaction information of the customer CL1 in the settlement device 22 in the step S4-11 enables an additional article registration for the customer CL1 by the settlement device 22.

When an additional article of the customer CL1 is registered by using the bar-code scanner 51 of the settlement device 22 in step S4-12, and the subtotal key K22 is pressed down in step S4-13, a subtotal of the transaction with the customer CL1 is displayed on the display unit 56 of the settlement device 22. The customer CL1 makes a payment according to the subtotal displayed on the display unit 56. When a deposit received from the customer CL1 is input in step S4-14, and the deposit/total key K23 is pressed down in step S4-15, payment information is added to the transaction information of the customer CL1, and the transaction information is stored in the transaction log database domain 83 of the server 13. FIG. 17C illustrates a screen image of the display unit 56 at this point. Additionally, a receipt concerning the transaction with the customer CL1 is printed out from the printer 54 in step S4-16.

As described above, when a transaction can be suspended and thereafter be resumed by the settlement device 22.

Thirdly, a description will be given of operations when the article registration device 21 suspends a transaction, and the settlement device 22 resumes the transaction.

FIG. 18 is a transaction process flowchart of the article registration device 21, when the article registration device 21 suspends a transaction, and the settlement device 22 resumes the transaction. FIG. 19 is a transaction process flowchart of the settlement device 22, when the article registration device 21 suspends a transaction, and the settlement device 22 resumes the transaction. FIG. 20A to FIG. 20C are screen transition diagrams of the settlement device 22, when the article registration device 21 suspends a transaction, and the settlement device 22 resumes the transaction.

To begin with, a description will be given of operations of the article registration device 21.

In the course of registering articles to be purchased by the customer CL1 in a transaction in step S5-1 shown in FIG. 18, when the suspension key K10 is pressed down in step S5-2, the transaction with the customer CL1 is suspended in step S5-3. The article information of the articles to be purchased by the customer CL1 is stored in the suspension database domain 84.

Suspending the transaction with the customer CL1 in the step S5-3 enables an article registration for the next customer CL2 in step S5-4. When the article registration for the customer CL2 is finished, the subtotal key K12 is pressed down in step S5-5, and the total key K13 is pressed down in step S5-6. Thereby, transaction information of the customer CL2 is supplied to the settlement device 22. The settlement device 22 stores the transaction information of the customer CL2 in the transaction log database domain 83 of the server 13. This enables a settlement for the customer CL2.

When the transaction with the customer CL1 is suspended by the article registration device 21 in the steps S5-2 and S5-3, the display unit 56 of the settlement device 22 displays a message “SUSPENSION”, as shown in FIG. 20A, which indicates that there is a suspended transaction. When the resumption key K27 of the settlement device 22 is pressed down in step S6-1 shown in FIG. 19, the transaction information of the customer CL1 is retrieved and resumed from the suspension database domain 84 of the server 13 in step S6-2. Thereupon, the resumed transaction information of the customer CL1 is displayed on the display unit 56 of the settlement device 22, as shown in FIG. 20B. In this course, when the transaction information of the next customer CL2 is stored in the transaction log database domain 83 in the step S5-6, the display unit 56 displays a message “MEMORY”, as shown in FIG. 20B, which indicates that there is a transaction waiting to be settled.

Resuming the transaction information of the customer CL1 in the step S6-2 enables an additional article registration to the transaction information of the customer CL1 by using the bar-code scanner 51 of the settlement device 22 in step S6-3. In the course of the article registration, article information of an article to be registered is obtained from the PLU master database domain 82 of the server 13. When the subtotal key K22 is pressed down in step S6-4, a subtotal of the transaction with the customer CL1 is displayed on the display unit 56.

When a deposit received from the customer CL1 is input in step S6-5, and the deposit/total key K23 is pressed down in step S6-6, payment information is added to the transaction information of the customer CL1, and the transaction information is stored in the transaction log database domain 83 of the server 13. Additionally, a receipt concerning the transaction with the customer CL1 is printed out from the printer 54 in step S6-7.

When the subtotal key K22 is pressed down in step S6-8, the settlement device 22 obtains the transaction information of the customer CL2 from the transaction log database domain 83 of the server 13 in step S6-9. At this point, the display unit 56 of the settlement device 22 displays the transaction information of the customer CL2, as shown in FIG. 20C.

When a deposit received from the customer CL2 for payment is input in step S6-10, and the deposit/total key K23 is pressed down in step S6-11, payment information is added to the transaction information, and the transaction information is stored in the transaction log database domain 83 of the server 13. Additionally, a receipt concerning the transaction with the customer CL2 is printed out from the printer 54 in step S6-12.

As described above, a transaction suspended by the article registration device 21 can be resumed and settled by the settlement device 22. Accordingly, a transaction suspended by the article registration device 21 can be transacted by the settlement device 22, when an article registration for another transaction is performed in the article registration device 21, and no operations are performed in the settlement device 22; thereby, an efficiency of the above-mentioned twosome operation is improved.

Fourthly, a description will be given of operations when the settlement device 22 suspends a transaction, and the article registration device 21 resumes the transaction.

FIG. 21 is a transaction process flowchart of the article registration device 21, when the settlement device 22 suspends a transaction, and the article registration device 21 resumes the transaction. FIG. 22 is a transaction process flowchart of the settlement device 22, when the settlement device 22 suspends a transaction, and the article registration device 21 resumes the transaction. FIG. 23A to FIG. 23G are screen transition diagrams of the customer-side display 33 and the checker-side display 34, when the settlement device 22 suspends a transaction, and the article registration device 21 resumes the transaction. FIG. 24A to FIG. 24C and FIG. 25A and FIG. 25B are screen transition diagrams of the display unit 56 of the settlement device 22, when the settlement device 22 suspends a transaction, and the article registration device 21 resumes the transaction.

To begin with, a description will be given of operations of the article registration device 21.

When an article to be purchased by the customer CL1 in a transaction is registered in step S7-1 shown in FIG. 21, the settlement device 22 refers to the PLU master database domain 82 so as to obtain article information of the article. The displays 33 and 34 of the article registration device 21 display the article information of the registered article, as shown in FIG. 23A. When the subtotal key K12 is pressed down in step S7-2, and the total key K13 is pressed down in step S7-3, the settlement device 22 stores transaction information of the customer CL1 in the transaction log database domain 83. At this point, since the transaction with the customer CL1 is unsettled, the displays 33 and 34 display “∇” above “MEMORY”, as shown in FIG. 23B, which indicates that there is an unsettled transaction.

When the subtotal key K22 of the settlement device 22 is pressed down in step S8-1 shown in FIG. 22 so that the settlement device 22 obtains and displays the transaction information of the customer CL1 in step S8-2 (described in detail hereinafter), “∇” above “MEMORY” which indicates that there is an unsettled transaction is cleared, as shown in FIG. 23C. Pressing down the total key K13 in the step S7-3 enables an article registration for the next customer CL2. After the article registration for the customer CL2 is performed in step S7-4, and the subtotal key K12 is pressed down in step S7-5, the total key K13 is pressed down in step S7-6 such that transaction information of the customer CL2 is stored in the transaction log database domain 83.

Thus, the article registrations for the customers CL1 and CL2 by the article registration device 21 are finished.

At this point, a description will be given of operations of the settlement device 22.

After the article registration for the customer CL1 is finished in the step S7-3, the subtotal key K22 is pressed down in the step S8-1 so as to obtain and display the transaction information of the customer CL1 in the step S8-2. In this course, the display unit 56 of the settlement device 22 transits from an image shown in FIG. 24A to an image shown in FIG. 24B. When the suspension key K26 of the settlement device 22 is pressed down in step S8-3, the transaction information of the customer CL1 is stored in the suspension database domain 84 so that the transaction with the customer CL1 is suspended, in step S8-4. At this point, the displays 33 and 34 of the article registration device 21 display “∇” above “SUSPENSION”, as shown in FIG. 23D, so that it can be recognized that there is a suspended transaction. Also at this point, when the transaction information of the next customer CL2 is already stored in the transaction log database domain 83 in the step S7-6, and thus is waiting to be settled, the displays 33 and 34 display “∇” above “MEMORY”, as shown in FIG. 23D, which indicates that there is an unsettled transaction.

Also at this point, the display unit 56 of the settlement device 22 displays a message “SUSPENSION”, as shown in FIG. 24C, which indicates that there is a suspended transaction. Also at this point, if the transaction information of the next customer CL2 is already stored in the transaction log database domain 83 in the step S7-6, the display unit 56 displays a massage “MEMORY”, as shown in FIG. 24C, which indicates that there is a transaction waiting to be settled.

When the subtotal key K22 of the settlement device 22 is pressed down in step S8-5, the settlement device 22 obtains the transaction information of the customer CL2 from the transaction log database domain 83 of the server 13 in step S8-6 so as to perform a settlement of the transaction with the customer CL2.

When a deposit received from the customer CL2 is input in step S8-7, and the deposit/total key K23 is pressed down in step S8-8, payment information is added to the transaction information of the customer CL2, and the transaction information of the customer CL2 is stored in the transaction log database domain 83. In addition, a receipt concerning the transaction with the customer CL2 is printed out from the printer 54 in step S8-9.

Here, the description given of operations of the article registration device 21 will be resumed from step S7-7 shown in FIG. 21.

After the transaction with the customer CL1 is suspended by the settlement device 22 in the step S8-3 and the step S8-4, and when the resumption key K11 of the article registration device 21 is pressed down in step S7-7, the transaction information of the customer CL1 is obtained and resumed from the suspension database domain 84 to the article registration device 21 in step S7-8. When the transaction information of the customer CL1 is resumed in the article registration device 21, the display unit 56 of the settlement device 22 clears the message “SUSPENSION”, as shown in FIG. 25A.

Further, the displays 33 and 34 of the article registration device 21 clear the marks “∇” from above “SUSPENSION” and “MEMORY”, as shown in FIG. 23E, and display a message “TRANSACTION RESUMED”, as shown in FIG. 23E.

Subsequently, when a bar code applied on an article to be purchased additionally by the customer CL1 is read by the stationary bar-code scanner 31 in step S7-9, article information of the article is displayed on the displays 33 and 34, as shown in FIG. 23F. When the subtotal key K12 is pressed down in step S7-10, and the total key K13 is pressed down in step S7-11, the transaction information of the customer CL1 is stored in the transaction log database domain 83 of the server 13 by the settlement device 22. At this point, the displays 33 and 34 of the article registration device 21 display “∇” above “MEMORY”, as shown in FIG. 23G, so as to indicate that the transaction with the customer CL1 is unsettled. Additionally, since the transaction with the customer CL1 is waiting to be settled, the display unit 56 of the settlement device 22 displays a massage “MEMORY”, as shown in FIG. 25A, which indicates that there is a transaction waiting to be settled by the settlement device 22.

Here, the description given of operations of the settlement device 22 will be resumed from step S8-10 shown in FIG. 22.

When the subtotal key K22 of the settlement device 22 is pressed down in step S8-10, the settlement device 22 obtains the transaction information of the customer CL1 from the transaction log database domain 83 of the server 13 in step S8-11. The settlement device 22 displays the obtained transaction information of the customer CL1 on the display unit 56. After a deposit received from the customer CL1 is input in step S8-12, and when the deposit/total key K23 is pressed down in step S8-13, payment information is added to the transaction information of the customer CL1, and the transaction information of the customer CL1 is stored in the transaction log database domain 83. At this point, the display unit 56 of the settlement device 22 displays an image including the transaction information of the customer CL1, as shown in FIG. 25B. In addition, a receipt concerning the transaction with the customer CL1 is printed out from the printer 54 in step S8-14.

The article registration device 21 and the settlement device 22 operate as described above, when the settlement device 22 suspends a transaction, and the article registration device 21 resumes the transaction. Accordingly, operations such as an additional article registration can be performed by the article registration device 21 with respect to a transaction suspended by the settlement device 22, when a settling operation for another transaction is performed in the settlement device 22, and no operations are performed in the article registration device 21; thereby, an efficiency of the above-mentioned twosome operation is improved.

The present invention is not limited to the specifically disclosed embodiments, and variations and modifications may be made without departing from the scope of the present invention.

The present application is based on Japanese priority application No. 2001-302170 filed on Sep. 28, 2001, the entire contents of which are hereby incorporated by reference.

What is claimed is:

1. A terminal apparatus comprising:
an article registration device inputting an article code so as to register a transaction;
a settlement device creating transaction information according to said article code input by said article registration device so as to subject said transaction to a settling operation according to said transaction information;
an article registration suspending unit suspending the transaction being registered by said article registration device in a suspended state;
an article registration resuming unit resuming the transaction suspended in said suspended state into said article registration device;
a settlement suspending unit suspending the transaction being subjected to said settling operation by said settlement device in said suspended state; and
a settlement resuming unit resuming the transaction suspended in said suspended state into said settlement device.

2. The terminal apparatus as claimed in claim 1, wherein said article registration resuming unit is capable of resuming the transaction suspended in said suspended state by said article registration suspending unit into said article registration device.

3. The terminal apparatus as claimed in claim 1, wherein said settlement resuming unit is capable of resuming the transaction suspended in said suspended state by said settlement suspending unit into said settlement device.

4. The terminal apparatus as claimed in claim 1, wherein said article registration resuming unit is capable of resuming the transaction suspended in said suspended state by said settlement suspending unit into said article registration device.

5. The terminal apparatus as claimed in claim 1, wherein said settlement resuming unit is capable of resuming the transaction suspended in said suspended state by said article registration suspending unit into said settlement device.

6. A transaction management system comprising:
an article registration device inputting an article code so as to register a transaction;
a management device storing said article code input by said article registration device;
a settlement device reading said article code input by said article registration device from said management system, and creating transaction information according to said article code so as to subject said transaction to a settling operation according to said transaction information, and to store said transaction information in said management system;
an article registration suspending unit suspending the transaction being registered by said article registration device by storing said transaction in said management system;
an article registration resuming unit resuming the suspended transaction stored in said management system into said article registration device;
a settlement suspending unit suspending the transaction being subjected to said settling operation by said settlement device by storing said transaction in said management system; and
a settlement resuming unit resuming the suspended transaction stored in said management system into said settlement device.

7. The transaction management system as claimed in claim 6, wherein said article registration resuming unit is capable of resuming the suspended transaction stored in said management system by said article registration suspending unit into said article registration device.

8. The transaction management system as claimed in claim 6, wherein said settlement resuming unit is capable of resuming the suspended transaction stored in said management system by said settlement suspending unit into said settlement device.

9. The transaction management system as claimed in claim 6, wherein said article registration resuming unit is capable of resuming the suspended transaction stored in said management system by said settlement suspending unit into said article registration device.

10. The transaction management system as claimed in claim 6, wherein said settlement resuming unit is capable of resuming the suspended transaction stored in said management system by said article registration suspending unit into said settlement device.

11. A transaction processing method comprising:
the article registering step of inputting an article code so as to register a transaction;
the settling step of creating transaction information according to said article code so as to settle said transaction according to said transaction information, the settling step being performed in parallel with said article registering step;
the article registration suspending step of suspending the transaction being registered by said article registering step;
the settlement suspending step of suspending the transaction being settled by said settling step in a suspended state;
the article registration resuming step of resuming the transaction suspended in said suspended state so that said transaction is subjected to said article registering step; and
the settlement resuming step of resuming the transaction suspended in said suspended state so that said transaction is subjected to said settling step.

12. The transaction processing method as claimed in claim 11, wherein said article registration resuming step is capable of resuming the transaction suspended by said article registration suspending step so that said transaction is subjected to said article registering step.

13. The transaction processing method as claimed in claim 11, wherein said settlement resuming step is capable of resuming the transaction suspended in said suspended state by said settlement suspending step so that said transaction is subjected to said settling step.

14. The transaction processing method as claimed in claim 11, wherein said article registration resuming step is capable of resuming the transaction suspended by said settlement suspending step so that said transaction is subjected to said article registering step.

15. The transaction processing method as claimed in claim 11, wherein said settlement resuming step is capable of resuming the transaction suspended in said suspended state by said article registration suspending step so that said transaction is subjected to said settling step.

16. A computer readable medium storing program code for causing a computer to process a transaction, the medium comprising:
article registration suspending program code means for suspending the transaction being registered by an article registering step of inputting an article code;
settlement suspending program code means for suspending the transaction being settled by a settling step of creating transaction information according to said article code input by said article registering step so as to settle said transaction according to said transaction information;
article registration resuming program code means for resuming the suspended transaction so that said suspended transaction is subjected to said article registering step; and
settlement resuming program code means for resuming the suspended transaction so that said suspended transaction is subjected to said settling step.

17. The medium as claimed in claim 16, wherein said article registration resuming program code means is capable of resuming the transaction suspended by said article registration suspending program code means so that said transaction is subjected to said article registering step.

18. The medium as claimed in claim 16, wherein said settlement resuming program code means is capable of resuming the transaction suspended by said settlement suspending program code means so that said transaction is subjected to said settling step.

19. The medium as claimed in claim 16, wherein said article registration resuming program code means is capable of resuming the transaction suspended by said settlement suspending program code means so that said transaction is subjected to said article registering step.

20. The medium as claimed in claim 16, wherein said settlement resuming program code means is capable of resuming the transaction suspended by said article registration suspending program code means so that said transaction is subjected to said settling step.
